(19) United States
(12) Patent Application Publication
(10) Pub. No.: US 2011/0183880 A1
(43) Pub. Date: Jul. 28, 2011

(54) (METH) ACRYLIC ACID-BASED COPOLYMER, METHOD FOR PRODUCING THE SAME AND DETERGENT COMPOSITION USING THE SAME

(75) Inventors: Atsuro Yoneda, Osaka (JP); Akiko Hemmi, Osaka (JP)

(73) Assignee: Nippon Shokubai Co., Ltd, Osaka-shi, OSAKA (JP)

(21) Appl. No.: 12/160,549

(22) PCT Filed: Jan. 30, 2007
(86) PCT No.: PCT/JP2007/051870

§ 371 Date: Jul. 10, 2008

(30) Foreign Application Priority Data
Jan. 31, 2006 (JP) 2006-023858
Jan. 31, 2006 (JP) 2006-023860
Jan. 31, 2006 (JP) 2006-023862
Jan. 31, 2006 (JP) 2006-023863

(51) Int. Cl. C11D 3/37; C08F 220/18; C08F 226/02; C08F 220/28; C08F 228/02; C08F 220/06; C08F 2/38

(52) U.S. Cl. 510/299; 526/318.41; 526/312; 526/318.42; 526/287; 526/318.5; 526/89; 526/234

(57) ABSTRACT

The present invention provides a (meth)acrylic acid-based copolymer useful to a detergent which is excellent in efficient removal capability of soil of clothes (in particular, hydrophobic soil such as collar dirt or greasy dirt), and prevention capability of soil redeposition, not to re-adhere the soil to laundries, even in carrying out washing with small amount of water. The present invention provides a (meth)acrylic acid-based copolymer comprising, as repeating units: a repeating unit (a) derived from a (meth)acrylic acid-based monomer (A) represented by the formula (1); and a repeating unit (b) derived from an alkyl(meth)acrylate-based monomer (B) represented by the formula (2) or a repeating unit (c) derived from a vinyl aromatic-based monomer (C); and 1 or, 2 or more kinds of repeating units (d) selected from the group consisting of a repeating unit (d-1) derived from an unsaturated monomer (D-1) represented by the formula (3), a repeating unit (d-2) derived from an unsaturated monomer (D-2) represented by the formula (4) a repeating unit (d-3) derived from a hydroxyalkyl(meth)acrylate-based monomer (D-3) represented by the formula (5), and a repeating unit (d-4) derived from a sulfonic acid group containing monomer (D-4) represented by the formula (6). Furthermore, the present invention provides a method for producing said (meth)acrylic acid-based copolymer.

### TECHNICAL FIELD

The present invention relates to a (meth)acrylic acid-based copolymer, a method for producing the same, and a detergent composition using the same. In particular, the present invention relates to a (meth)acrylic acid-based copolymer excellent in removal capability of hydrophobic soil such as soil of clothes, in particular, collar dirt or greasy dirt or the like, and prevention capability of soil redeposition thereof, a method for producing the same, and a detergent composition using the same.

### BACKGROUND ART

Conventionally, for detergents used for clothing, the detergents formulated with builders such as zeolite, carboxymethyl cellulose and polyethylene glycol, as preventive agents for soil redeposition, are known. These builders, however, are not satisfactory as a detergent composition due to not exhibiting sufficient cleaning effect to, for example, both a cotton fiber with relatively high hydrophilic nature, and a highly hydrophobic synthetic fiber like a polyester blended cloth, along with having insufficient prevention capability of soil redeposition to prevent adhesion of clay during washing, and thus further performance improvement has been desired. In addition to the above points, with recent concern to environmental problems, challenges to reduce water amount used in washing have been actively taken. However, reduced amount of water in washing in one time dominantly incurs a soil redeposition problem, namely re-adhesion of soil in water to laundries, due to increased concentration of soil in water. Therefore, for example, a hydrophilic polymer such as a (co)polymer of an unsaturated carboxylic acid such as acrylic acid, methacrylic acid, a-hydroxyacrylic acid, itaconic acid, maleic acid, fumaric acid, or crotonic acid, or citraconic acid; a graft polymer obtainable by graft-polymerization of an unsaturated carboxylic acid-based monomer like (meth)acrylic acid onto a polyether compound is formulated. These polymers, however, have little effect in removing hydrophobic soil like fat and oil, which is one of major soil components adhered to clothes, and thus have insufficient preventive effect for soil redeposition, although they are effective to hydrophilic particulate soil like clay.

Conventionally, as a method for improving soil removal characteristics of, in particular, hydrophobic soil like oily soil, use of a polycarboxylate polymer modified to be hydrophobic, as a soil removing additive (namely, a detergent builder) has been proposed (for example, see JP-A-2000-143738).

Further, as a (meth)acrylic acid-based copolymer which can be used as a detergent builder or the like, a copolymer containing a repeating unit derived from a (meth)aryl ether-based monomer having a sulfonic acid(salt) group at the side chain has also been disclosed (see, for example, JP-A-2002-3536).

On the other hand, use of a copolymer of a (meth)acrylic acid-based monomer and an unsaturated polyalkylene glycol-based monomer in a detergent builder or a detergent composition has been reported (see, for example, JP-A-2004-75977). In JP-A-2004-75977, a composition of a polymer has been disclosed, which polymer is obtained by copolymerization of a (meth)acrylic acid-based monomer A and an unsaturated polyalkylene glycol-based monomer B having repeating units of polyalkylene oxide in an amount of equal to or more than 6 and equal to or less than 300, along with an monoethylenic unsaturated monomer C copolymerizable with the monomers A and B, and copolymer thereof has sulfur oxyacid at the terminal and S value of sulfur element introduced amount of equal to or more than 3, which value is defined by S=(S amount contained in the polymer)/(total S amount)×100. This polymer composition has advantage of being excellent in compatibility with a liquid detergent or dispersibility, and good hue.

Moreover, an amino group containing water-soluble copolymer is capable of exerting as a polymer-based builder, due to characteristics originated from an amino group, or a group expressing water-solubility, or the like. A detergent containing such a polymer is required to have detergency originated from clay dispersing performance or the like, or stabilization capability of a bleaching agent, in addition, in the case where it is used as a component composing a liquid detergent, dissolving nature in a liquid detergent is required.

Conventionally, an amino group containing polymer used in a detergent builder and a detergent composition containing the same, has been disclosed in JP-A-5-311194. This polymer is produced by a method for polymerization of an amino group containing monomer synthesized from an imino group containing compound and an allyl glycidyl ether with acrylic acid etc., and has a functional group like a hydroxyl group at the side chain, and an amino group at the side chain terminal.

### DISCLOSURE OF THE INVENTION

As described above, conventionally, there are proposals that many polymers can be used as detergent builders. However, even in the case where these polymers are used as detergent builders, removal capability or prevention capability of soil redeposition against hydrophobic soil such as collar dirt or greasy dirt was not necessarily sufficient.

As described above, although various detergent compositions have conventionally been reported, there are no detergents sufficiently satisfying both performances, and requirement to such a detergent is still strong that is capable of efficiently removing soil of clothes or the like, (in particular, hydrophobic soil such as collar dirt or greasy dirt) and excellent in prevention capability of soil redeposition not to redeposit the soil to laundries, even when washing is carried out using small amount of water.

Therefore, it is an object of the present invention to provide a (meth)acrylic acid-based copolymer useful for a detergent which is capable of efficiently removing soil of clothes, (in particular, hydrophobic soil such as collar dirt or greasy dirt) and excellent in prevention capability of soil redeposition not to redeposit the soil to laundries, even when washing is carried out using small amount of water.

It is another object of the present invention to provide a method for efficiently producing such a (meth)acrylic acid-based copolymer.

It is still another object of the present invention to provide a detergent composition useful for a detergent which is capable of efficiently removing soil of clothes, (in particular, hydrophobic soil such as collar dirt or greasy dirt) and excellent in prevention capability of soil redeposition not to redeposit the soil to laundries, even when washing is carried out using small amount of water.

The present inventors have extensively studied on various polymers/copolymers to attain the above-described objectives, and, as a result, found that the above objectives can be attained by a copolymer which is further introduced with repeating units exhibiting relatively hydrophobic nature derived from an alkyl(meth)acrylate-based monomer or a vinyl aromatic-based monomer, in addition to repeating units derived from a (meth)acrylic acid-based monomer and repeating units derived from a specified hydrophilic monomer (specifically, a specified unsaturated polyalkylene glycol-based monomer, a specified amino group containing monomer, a specified hydroxyalkyl(meth)acrylate-based monomer, or a specified sulfonic acid group containing monomer). Namely, use of such a copolymer as a detergent builder is capable of efficiently removing soil of clothes or the like, (in particular, hydrophobic soil such as collar dirt or greasy dirt) and at the same time exerting excellent prevention capability of soil redeposition not to redeposit the soil to laundries, even when washing is carried out using small amount of water, and have thus completed the present invention based on such knowledge.

Specifically, according to the first aspect of the present invention,
a (meth)acrylic acid-based copolymer having, as repeating units :
a repeating unit (a) derived from a (meth)acrylic acid-based monomer (A) represented by the following formula (1)

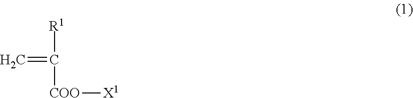

wherein R¹ represents a hydrogen atom or a methyl group, and X¹ represents a hydrogen atom, a metal atom, an ammonium group or an organic amine group; and
a repeating unit (b) derived from an alkyl(meth)acrylate-based monomer (B) represented by the following formula (2):

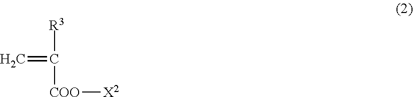

wherein R³ represents a hydrogen atom or a methyl group, and X² represents a (C1 to C12) alkyl group or a (C3 to C12) cycloalkyl group or a (C5 to C12) hydroxyalkyl group; or
a repeating unit (c) derived from a vinyl aromatic-based monomer (C); and
1 or, 2 or more kinds of repeating units (d) selected from the group consisting of:
a repeating unit (d-1) derived from an unsaturated monomer (D-1) represented by the following formula (3):

R⁴—O-(AO)ₙ—R⁵ (3)

wherein R⁴ represents a (C2 to C5) alkenyl group; AO may be the same or different and represents a group derived from a (C2 to C20) alkylene oxide; R5 represents a hydrogen atom or a (C2 to C5) alkyl group; and n is an integer of 1 to 200; a repeating unit (d-2) derived from an unsaturated monomer (D-2) represented by the following formula (4):

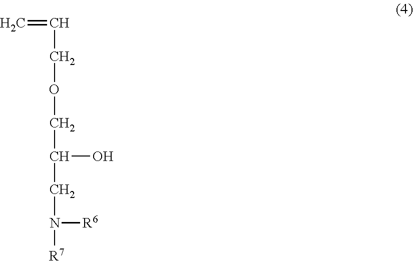

wherein R⁶ and R⁷ may be the same or different and represent a hydrogen atom or an organic group;
a repeating unit (d-3) derived from a hydroxyalkyl(meth)acrylate-based monomer (D-3) represented by the following formula (5):

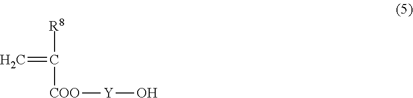

wherein R⁸ represents a hydrogen atom or a methyl group, and Y represents a (C1 to C4) alkylene group; and
a repeating unit (d-4) derived from a sulfonic acid group containing monomer (D-4) represented by the following formula (6):

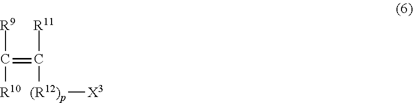

wherein R⁸, R¹⁰ and R¹¹ may be the same or different and represent a hydrogen atom or a methyl group, p represents 0 or 1, provided that when p is 1, R¹² represents —CH₂—, —CH₂—CH₂—, —CH₂—O—CH₂—, —CO—O—CH₂—CH₂—, or —CO—NH—C(CH₃)₂—, and X³ represents —SO₃X⁴ or —CHR¹³—CH₂R¹⁴, and in this case, X⁴ has the same definition as in X¹ in the above formula (1), and R¹³ and R¹⁴ may be the same or different and represent —OH or —SO₃X⁴, and at least one of R¹³ and R¹⁴ represents —SO₃X⁴,
is provided.

In addition, according to the second aspect of the present invention, a method for producing the above-described (meth)acrylic acid-based copolymer is provided.

In addition, according to the third aspect of the present invention, a detergent composition containing the above-described (meth)acrylic acid-based copolymer is provided.

Further other objectives, features and advantages of the present invention will be clear by referring to preferable embodiments exemplified in the following explanation.

### DETAILED DESCRIPTION OF THE EMBODIMENT

The present invention is explained in detail below by classifying into several embodiments, however, the scope of the present invention should be determined based on description of the claims, and should not be limited to the following specific embodiments.

The first aspect of the present invention is a (meth)acrylic acid-based copolymer having, as repeating units:
a repeating unit (a) derived from a (meth)acrylic acid-based monomer (A) represented by the following formula (1):

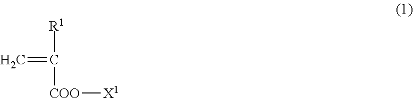

wherein R¹ represents a hydrogen atom or a methyl group, and X¹ represents a hydrogen atom, a metal atom, an ammonium group or an organic amine group; and
a repeating unit (b) derived from an alkyl(meth)acrylate-based monomer (B) represented by the following formula (2):

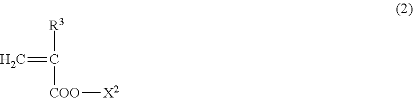

wherein R³ represents a hydrogen atom or a methyl group, and X² represents a (C1 to C12) alkyl group or a (C3 to C12) cycloalkyl group or a (C5 to C12) hydroxyalkyl group; or
a repeating unit (c) derived from a vinyl aromatic-based monomer (C); and
1 or, 2 or more kinds of repeating units (d) selected from the group consisting of:
a repeating unit (d-1) derived from an unsaturated monomer (D-1) represented by the following formula (3):

R⁴—O-(AO)ₙ—R⁵ (3)

wherein R⁴ represents a (C2 to C5) alkenyl group; AO may be the same or different and represents a group derived from a (C2 to C20) alkylene oxide; R5 represents a hydrogen atom or a (C2 to C5) alkyl group; and n is an integer of 1 to 200; a repeating unit (d-2) derived from an unsaturated monomer (D-2) represented by the following formula (4):

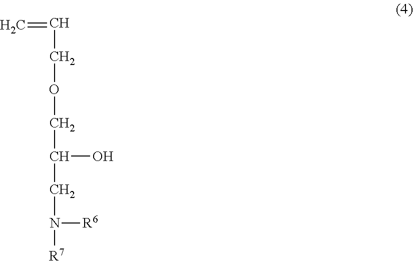

wherein R⁶ and R⁷ may be the same or different and represent a hydrogen atom or an organic group;
a repeating unit (d-3) derived from a hydroxyalkyl(meth)acrylate-based monomer (D-3) represented by the following formula (5):

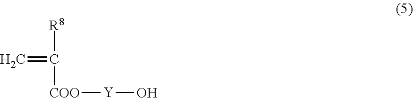

wherein R⁸ represents a hydrogen atom or a methyl group, and Y represents a (C1 to C4) alkylene group; and
a repeating unit (d-4) derived from a sulfonic acid group containing monomer (D-4) represented by the following formula (6):

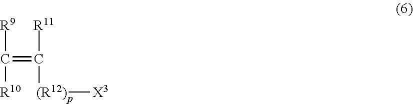

wherein R⁹, R¹⁰ and R¹¹ may be the same or different and represent a hydrogen atom or a methyl group, p represents 0 or 1, provided that when p is 1, R¹² represents —CH₂H—, —CH₂—CH₂—, —CH₂—O—CH₂—, —CO—O—CH₂—CH₂—, or —CO—NH—C(CH₃)₂—, and X³ represents —SO₃X⁴ or —CHR¹³—CH₂R¹⁴, and in this case, X⁴ has the same definition as in X¹ in the above formula (1), and R¹³ and R¹⁴ may be the same or different and represent —OH or —SO₃X⁴, and at least one of R¹³ and R¹⁴ represents —SO₃X⁴.

The (meth)acrylic acid-based copolymer of the present aspect is characterized by composing in combination with the repeating units (a) and (d) having relatively hydrophilic or hydrophilic nature, along with the repeating units (b) and/or (c) having relatively hydrophobic or hydrophobic nature. According to the present aspect, by introduction of the repeating units (a) and (d), excellent cleaning capability to a relatively highly hydrophilic cotton fiber or the like, along with excellent effect of dispersibility or prevention capability of soil redeposition to relatively hydrophilic soil, (in particular clay) is exerted. And at the same time, by further introduction of the repeating units (b) and/or (d), sufficient cleaning effect to hydrophobic synthetic fiber can be exerted, and prevention capability of soil redeposition to prevent adhesion of soil (in particular, hydrophobic soil such as greasy dirt or the like) during washing can significantly be enhanced. Therefore, the (meth)acrylic acid-based copolymer of the present invention is capable of exhibiting sufficient cleaning effect and prevention capability of soil redeposition to both hydrophilic soil and hydrophobic soil.

Reason for the (meth)acrylic acid-based copolymer of the present aspect to exert excellent cleaning effect and prevention capability of soil redeposition also to hydrophobic soil is not clear, however, it is considered as follows. Namely, it is inferred that a conventional polymer/copolymer composed of hydrophilic repeating units such as the repeating unit (a) or (d) has low interaction with hydrophobic soil, which makes difficult to well remove relatively highly hydrophobic soil such as collar dirt or greasy dirt, however, introduction of the repeating units (b) and/or (c) exhibiting relatively hydrophobic nature themselves, as in the present aspect, is capable of exerting sufficient cleaning effect and prevention capability of soil redeposition to hydrophobic soil, due to significantly increasing dispersion capability of these soils by enhanced interaction with hydrophobic soil.

The (meth)acrylic acid-based copolymer of the present aspect is explained below, by classifying into several embodiments depending on kinds of monomers which form the repeating unit (d). Here, as described above, the repeating unit (d) is selected from the group consisting of the repeating unit (d-1), the repeating unit (d-2), the repeating unit (d-3), and the repeating unit (d-4), however, in the explanation below, a monomer which forms the repeating unit (d) is simply referred to as “the monomer (D)”. Namely, “the monomer (D)” is selected from the group consisting of the monomer (D-1), the monomer (D-2), the monomer (D-3), and the monomer (D-4).

### The First Embodiment

In the present embodiment, the repeating unit (d) is the repeating unit (d-1). Namely, the monomer (D) is the unsaturated monomer (D-1) represented by the following formula (3):

R⁴—O-(AO)ₙ—R⁵ (3)

Explanation is given in detail below on repeating units contained in the (meth)acrylic acid-based copolymer of the present embodiment, namely the repeating unit (a), the repeating unit (b), the repeating unit (c), and the repeating unit (d-1). Note that in the (meth)acrylic acid-based copolymer of the present embodiment, inclusion of at least one of the repeating unit (b) and the repeating unit (c) may be enough. Both of the repeating unit (b) and the repeating unit (c) may be included in the (meth)acrylic acid-based copolymer of the present embodiment.

### (Repeating Unit (a))

The repeating unit (a) is derived from the (meth)acrylic acid-based monomer (A) represented by the following formula (1):

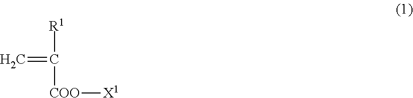

In the present embodiment, the repeating unit (a) maybe present alone or in a mixture form of two or more kinds. In addition, the repeating unit (a) becomes a form of (—CH₂—C(R¹)(COO—X¹)—) where a double bond in the formula (1) is converted to a single bond.

In the above formula (1), R¹ represents a hydrogen atom or a methyl group.

In the above formula (1), X¹ represents a hydrogen atom, a metal atom, an ammonium group or an organic amine group. In this case, the metal atom preferably includes a monovalent metal atom of an alkali metal such as sodium, lithium, potassium, rubidium, cesium; a divalent metal atom of an alkaline earth metal such as magnesium, calcium, strontium, barium; a trivalent metal atom such as aluminum, iron. In addition, the organic amine group preferably includes a group derived from an organic amine such as an alkanol amine including monoethanol amine, diethanol amine, trietanol amine or the like; an alkyl amine such as monoethylamine, diethylamine, triethylamine or the like; a polyamine such as ethylene diamine, triethylene diamine. Among these, X¹ is preferably a hydrogen atom, ammonium, sodium, or potassium, and more preferably a hydrogen atom or sodium.

The (meth)acrylic acid-based monomer (A) which forms such the repeating unit (a) is represented by the above formula (1), and a specific form thereof is not especially limited, for example, acrylic acid, methacrylic acid, crotonic acid or the like; a monovalent metal salt, a divalent metal salt, an ammonium salt, an organic amine salt thereof or the like is preferable. Among these, (meth)acrylic acid, a monovalent metal salt, a divalent metal salt, an ammonium salt, an organic amine salt thereof or the like is preferably used, in a detergent composition application, in view of improvement of dispersing performance. In addition, the (meth)acrylic acid-based monomer (A) may be a half ester between an unsaturated dicarboxylic acid-based monomer and a (C1 to C22) alcohol, a half amide between an unsaturated dicarboxylic acid and a (C1 to C22) amine, a half ester between an unsaturated dicarboxylic acid-based monomer and a (C2 to C4) glycol, a half amide between a maleamic acid and a (C2 to C4) glycol, or the like.

In the (meth)acrylic acid-based copolymer of the present embodiment, content of the above repeating unit (a) is preferably equal to or more than 30% by mass and less than 95% by mass, based on total content of the repeating units (a) to (d-1), as 100% by mass. In consideration of balance of the effects exerted by the repeating units (a), (b), (c) and (d-1), content of the repeating unit (a) is more preferably 35 to 90% by mass, further preferably 35 to 85% by mass, and most preferably 40 to 80% by mass. In the mean time, the content of the repeating unit (a) is calculated as reduced value of the corresponding acid. In this case, too low content of the repeating unit (a) in the (meth)acrylic acid-based copolymer is not capable of sufficiently exerting the effect obtainable by a hydrophilic group of the (meth)acrylic acid-based monomer (A), causing a problem of reducing cleaning capability to hydrophilic or relatively hydrophilic soil (for example, clay). On the other hand, too high content of the repeating unit (a) in the (meth)acrylic acid-based copolymer results in too low content of the other repeating units (b), (c) and (d-1), and is not capable of sufficiently exerting the effect of these repeating units, causing a problem of reducing cleaning capability to hydrophobic or relatively hydrophobic soil (for example, oily soil). In addition to the above problem, too high content of the repeating unit (a) could make difficult efficient production of a desired copolymer.

### (Repeating Unit (b))

The (meth)acrylic acid-based copolymer of the present embodiment contains at least one of the repeating units (b) and (c), in addition to the above-described repeating unit (a) and the repeating unit (d-1) to be described later. The copolymer of the present embodiment, owing to introduction of the relatively hydrophobic repeating units (b) and (c), as described-above, is capable of improving dispersibility of hydrophilic soil by effective interaction with hydrophobic substances, and therefore is capable of efficiently removing hydrophobic soil such as collar dirt or greasy dirt, and significantly improving prevention capability of soil redeposition, not to redeposit hydrophobic soil to laundries, even under stringent condition like washing with small amount of water.

The repeating unit (b) is derived from the alkyl(meth)acrylate-based monomer (B) represented by the following formula (2):

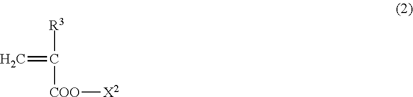

The repeating unit (b) in the present embodiment may be present alone or in a mixture form of two or more kinds. In addition, the repeating unit (b) becomes a form of (—CH₂—C(R³)(COO—X²)—) where a double bond in the above formula (2) is converted to a single bond.

In the above formula (2), R³ represents a hydrogen atom or a methyl group.

In the above formula (2), X² represents a (C₁-C₁₂) alkyl group, or a (C₃-C₁₂) cycloalkyl group, or a hydroxy (C₅-C₁₂) alkyl group. In this case, the (C₁-C₁₂) alkyl group is not especially limited as long as it is capable of exerting desired effect, and includes, for example, a straight chained or branched group such as a methyl group, an ethyl group, a propyl group, an isopropyl group, a n-butyl group, an isobutyl group, a sec-butyl group, a tert-butyl group, a pentyl group, an isopentyl group, a neopentyl group, a hexyl group, a heptyl group, an octyl group, a nonyl group, a decyl group, an undecyl group, a dodecyl group, a 2-ethylhexyl group. In addition, the (C₃-C₁₂) cycloalkyl group is not especially limited, as long as it is capable of exerting desired effect, and includes a cyclopropyl group, a cyclobutyl group, a cyclopentyl group, a cyclohexyl group, a cycloheptyl group and a cyclooctyl group. Furthermore, the hydroxy (C5 to C12) alkyl group is not especially limited, as long as it is capable of exerting desired effect, and includes a straight chained, branched or cyclic hydroxyalkyl group such as a hydroxypentyl group, a hydroxyohexyl group, a hydroxyheptyl group, a hydroxyneopentyl group, a hydroxyoctyl group, a hydroxynonyl group, a hydroxydecyl group, a hydroxyundecyl group, a hydroxydodecyl group. Among these, X² is preferably an-butyl group, a 2-ethylhexyl group, and a dodecyl group, and more preferably a n-butyl group, and a 2-ethylhexyl group.

Therefore, the alkyl(meth)acrylate-based monomer (B) which can preferably be used in the present embodiment includes a alkyl(meth)acrylate-based monomer such as butyl(meth)actylate, 2-ethylhexyl(meth)actylate, dodecyl(meth)acrylate; a hydroxyalkyl(meth)acrylate-based monomer such as hydroxypentyl(meth)acrylate, hydroxyneopentyl(meth)acrylate, hydroxyhexyl(meth)acrylate. Among these, butyl(meth)actylate, 2-ethylhexyl(meth)actylate, dodecyl(meth)acrylate, hydroxypentyl(meth)acrylate, hydroxyneopentyl(meth)acrylate are preferably used, and butyl(meth)actylate, and 2-ethylhexyl(meth)actylate are more preferably used.

### (Repeating Unit (c))

The repeating unit (c) is derived from a vinyl aromatic-based monomer (C). In the present embodiment, the repeating unit (c) may be present alone or in a mixture form of two or more kinds. In addition, the repeating unit (c) becomes a form of (—CH₂—CH₂—) where a double bond of a vinyl group is converted to a single bond.

The vinyl aromatic-based monomer (C) is not especially limited, as long as it is capable of exerting desired effect, and includes, for example, a vinyl aromatic-based monomer, having an aromatic hydrocarbon group such as styrene, a-methylstyrene, o-chlorostyrene, vinyltoluene, vinylnaphthalene, vinylanthracene; and a vinyl aromatic hydrocarbon monomer having a heterocyclic aromatic hydrocarbon group such as vinylpyridine, vinylimidzole or the like. In addition, the repeating unit (c) derived from the vinyl aromatic-based monomer (C) is preferably derived from a vinyl aromatic-based monomer having an aromatic hydrocarbon group, in view of interaction with hydrophobic soil (therefore, dispersibility of hydrophobic soil), and it is more preferable to satisfy any of the requirement of an aromatic group having a phenyl group, or being composed of only carbon atoms and hydrogen atoms. Among these, the vinyl aromatic-based monomer (C) is preferably styrene and vinyltoluene, styrene is particularly preferable.

In the (meth)acrylic acid-based copolymer of the present embodiment, total content of the above repeating units (b) and (c) is preferably over 0% by mass and less than 50% by mass, based on the total content of the repeating units (a) to (d-1), as 100% by mass, in consideration of balance of the effects exerted by the repeating units (a), (b), (c) and (d-1), the content is more preferably 1 to 40% by mass, further preferably 2 to 35% by mass, and most preferably 3 to 30% by mass. In this case, the total content of the repeating units (b) and (c) in the (meth)acrylic acid-based copolymer over 50% by mass results in too low content of the other repeating units (a) and (d-1), and is not capable of sufficiently exerting the effect by these repeating units, causing a problem of reducing cleaning capability to hydrophilic or relatively hydrophilic soil (for example, clay).

(Repeating Unit (d-1))

The repeating unit (d-1) is derived from the unsaturated monomer (D-1) represented by the following formula (3):

R⁴—O-(AO)ₙ—R⁵ (3)

In the present embodiment, the repeating unit (d-1) may be present alone or in a mixture form of two or more kinds. In addition, the repeating unit (d-1) becomes a form of (—CH₂—CH—) where a double bond of a (C2 to C5) alkenyl group represented by R⁴ in the formula (3) is converted to a single bond.

In the above formula (3), R⁴ represents a (C2 to C5) alkenyl group. The (C2 to C5) alkenyl group represented by R⁴ includes, for example, CH₂═CH—, CH₂═CHCH₂—, CH₂═CHCH₂CH₂—, CH₂═CHCH₂CH₂CH₂—, CH(CH₃)═CH—, CH(CH₃)═CHCH₂—, CH(CH₃)═CHCH₂CH₂—, CH₂═C(CH₃)—, CH₂═C(CH₃)CH₂—, CH₂═C(CH₃)CH₂CH₂—, CH(CH₃)═C(CH₃)— or CH(CH₃)═C(CH₃)CH₂— or the like. Among these, as R⁴, CH₂═C(CH₃)CH₂CH₂—, CH₂═CHCH₂—, CH₂═C(CH₃)CH₂— and CH₂═CH— are preferable and CH₂═C(CH₃)CH₂CH₂— and CH₂═CHCH₂— are more preferable.

In addition, in the above formula (3), AO represents a group derived from a (C2 to C20), preferably a (C2 to C18) alkylene oxide. In this case, a (C2 to C20) alkylene oxide includes styrene oxide, ethylene oxide, propylene oxide, 1-butylene oxide, 2-butylene oxide and isobutylene oxide or the like. Such alkylene oxide is preferably ethylene oxide, propylene oxide or 1-butylene oxide, more preferably ethylene oxide or propylene oxide, and most preferably ethylene oxide.

“n” represents average addition mole number of the above-described AO, and is an integer of 1 to 200, preferably 2 to 150 and more preferably 3 to 100. The “n” over 200 could not provide improvement the effect comparable to the increase in the AO addition mole number. In addition, viscosity of the (meth)acrylic acid-based copolymer extremely increases, and could make handling difficult. In addition, in the case where “n” is 2 or more, AO may be present alone or in a mixture form of 2 or more kinds. In addition, in the case where AO is present in a mixture form of 2 or more kinds, binding order of each AO is not especially limited.

In the above formula (3), R⁵ represents a hydrogen atom or a (C2 to C5) alkyl group. The (C2 to C5) alkyl group includes straight or branched alkyl group such as a methyl group, an ethyl group, a propyl group, an isopropyl group, a n-butyl group, an isobutyl group, a sec-butyl group, a tert-butyl group, a pentyl group, an isopentyl group, and a neopentyl group or the like, and a cycloalkyl group such as a cyclopropyl group, a cyclobutyl group, and a cyclopentyl group or the like. Among them, R³ is preferably a hydrogen atom, a methyl group, an ethyl group or a propyl group, and more preferably a hydrogen atom or a methyl group.

In the case where R⁴ is CH₂═C(CH₃)CH₂CH₂—, CH₂═CHCH₂—, or CH₂═C(CH₃)CH₂— in the above formula (3), R⁵ is particularly preferably a hydrogen atom.

Therefore, the unsaturated monomer (D-1), which can preferably be used in the present embodiment, includes a compound obtained by the addition of 1 to 200 moles, preferably 2 to 150 moles, further preferably 2 to 120 moles, and most preferably 3 to 100 moles of a (C2 to C20) alkylene oxide per 1 mole of unsaturated alcohol such as 3-methyl-3-butene-1-ol (isoprenol), 3-methyl-2-butene-1-ol, 2-methyl-3-butene-2-ol, allyl alcohol, methallyl alcohol or the like. In this case, isoprenol or methallyl alcohol is preferable in view of copolymerizability with other monomers composing the copolymer of the present embodiment.

In the (meth)acrylic acid-based copolymer of the present embodiment, content of the above repeating unit (d-1) is preferably equal to or more than 5% by mass and less than 70% by mass, and in view of balance of the effects exerted by the repeating units (a), (b), (c) and (d-1), more preferably 6 to 65% by mass, further preferably 8 to 60% by mass, and most preferably 10 to 55% by mass, based on the total content of the repeating units (a) to (d-1), as 100% by mass. In this case, too low content of the repeating unit (d-1) in the (meth)acrylic acid-based copolymer is not capable of sufficiently exerting the effect obtainable by an unsaturated monomer (D-1), causing a problem of reducing cleaning capability to hydrophilic or relatively hydrophilic soil (for example, clay). On the other hand, too high content of the repeating unit (d-1) in the (meth)acrylic acid-based copolymer results in too low content of the other repeating units (a), (b) and (c), therefore is not capable of sufficiently exerting the effect by these repeating units, causing a problem of reducing cleaning capability to hydrophobic or relatively hydrophobic soil (for example, oily soil). In addition to the above problem, too high content of the repeating unit (d-1) could make difficult efficient production of a desired copolymer.

### (Other Repeating Unit (e))

In the above section, the essential repeating units of the (meth)acrylic acid-based copolymer of the present embodiment were explained, however, the copolymer of the present embodiment may further contain the repeating unit (e) derived from other monomer (hereafter referred to simply as “monomer (E)”), in addition to the above-described repeating units (a), (b), (c) and (d-1). In the present embodiment, the repeating unit (e) may be present alone or in a mixture form of 2 or more kinds.

In this case, content of the repeating unit (e) in the copolymer of the present embodiment is not especially limited, however, considering not to inhibit the effect of the repeating units (a), (b), (c) and (d-1), which are essential repeating units, the content of the repeating unit (e) is preferably over 0% by mass and equal to or less than 10% by mass, more preferably over 0% by mass and equal to or less than 7% by mass, and most preferably over 0% by mass and equal to or less than 5% by mass, relative to total content of the repeating units (a), (b), (c) and (d-1), as 100% by mass. The content within these ranges is capable of maintaining the effects by the repeating units, namely, cleaning capability to hydrophilic or relatively hydrophilic soil (for example, clay) by the repeating units (a) and (d-1), which are essential repeating units, as well as high removal capability of hydrophobic soil like oil and fat soil and excellent prevention capability of soil redeposition, even under stringent condition like washing with small amount of water, by contribution of the repeating units (c) and (d), along with further providing the effect of the repeating unit (e), for example, chelating ability and viscosity adjusting capability and thus the content within these ranges is preferable. It should be noted that too high content of the repeating units (e) could generate gelling or a cross-linking reaction during preparation of the copolymer, which could reduce water solubility of the copolymer, decrease color tone or generate malodor.

The other monomer (E) which forms the other repeating unit (e) in the (meth)acrylic acid-based copolymer of the present embodiment is not especially limited as long as it is polymerizable with the above monomers (A) to (D-1), and is selected depending on desired effect, as appropriate. Specifically, a sulfonic acid-based monomer such as vinyl sufonic acid, styrene sulfonic acid and a salt thereof ; an N-vinyl monomer such as N-vinylpyrrolidone, N-vinylformamide, N-vinylacetamide, N-vinyl-N-methylformamide N-vinyl-N-methylacetamide, N-vinyloxazolidone; an amide-based monomer such as (meth)acrylamide, N,N-dimethylacrylamide, or N-isopropylacrylamide; an allyl ether-based monomer such as 3-(meth)allyloxy-1,2-dihydroxypropane, 3-allyloxy-1,2-dihydroxypropane, 3-allyloxy-1,2-dihydroxypropane added with 1 to 200 moles of ethylene oxide (3-allyloxy-1,2-di(poly)oxyethylene ether propane, or the like), (meth)allyl alcohol; an isoprene-based monomer like isoprenol or the like; a-hydroxymethylacrylic acid and a derivative thereof; or an unsaturated dicarboxylic acid such as itaconic acid, fumaric acid, maleic acid, and a salt thereof or the like is included. In this case, the unsaturated dicarboxylic acid-based monomer may be any one as long as it has one unsaturated group and 2 carboxyl groups within a molecule, and maleic acid, itaconic acid, citraconic acid, fumaric acid or the like, and a monovalent metallic salt, a divalent metallic salt, an ammonium salt and an organic ammonium salt (organic amine salt) thereof or the like, or anhydride thereof is preferable. In the case where these monomers (E) form the other repeating unit (e) in the copolymer of the present embodiment, a double bond which these monomers (E) have takes a single bond form.

The (meth)acrylic acid-based copolymer of the present embodiment may be any one as long as it is introduced with the above-described repeating units (a), (b), (c) and (d), along with the repeating unit (e), if necessary, each repeating unit may be present in any form of a block state or a random state.

Weight average molecular weight of the (meth)acrylic acid-based copolymer of the present embodiment may be specified as appropriate, and not especially limited. Specifically, weight average molecular weight of the (meth)acrylic acid-based copolymer is preferably 2,000 to 100, 000, more preferably 3,000 to 80,000, and most preferably 4,000 to 60,000. The weight average molecular weight less than 2,000 reduces dispersibility for soil and could reduce also prevention capability of soil redeposition, while the weight average molecular weight over 100,000 could promote adhesion of soil to clothes. Note that, in the present invention, weight average molecular weight is a measurement value with GPC (Gel Permeation Chromatography), and is calculated by a specific measurement method described in the Example.

### The Second Embodiment

In the present embodiment, the repeating unit (d) is the repeating unit (d-2). Namely, the monomer (D) is the unsaturated monomer (D-2) represented by the following formula (4):

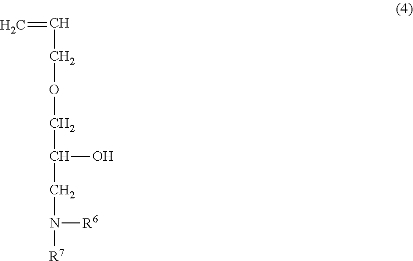

Explanation is given below on the repeating units contained in the (meth)acrylic acid-based copolymer of the present embodiment, however, specific embodiments of the repeating unit (a), the repeating unit (b), and the repeating unit (c) are the same as in the first embodiment. Therefore, detailed explanation on them is omitted here.

(Repeating Unit (d-2))

The repeating unit (d-2) is derived from the unsaturated monomer (D-2) represented by the following formula (4):

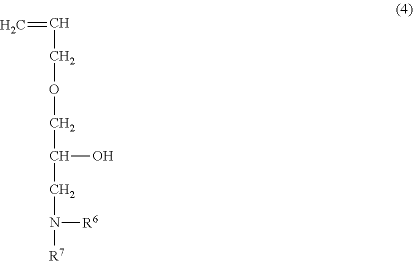

In the present embodiment, the repeating unit (d-2) may be present alone or in a mixture form of two or more kinds. Note that an amino group in the above formula (4) may take a quaternary form. In addition, the repeating unit (d-2) becomes a form of (—CH₂—CH—) where a double bond of a vinyl group is converted to a single bond.

In the formula (4), R⁶ and R⁷ represent a hydrogen atom or an organic group. In this case, R⁶ and R⁷ may be the same or different. In addition, the organic group represented by R⁶ and R⁷ are not especially limited, however, preferably a straight chained, branched or cyclic hydrocarbon group of preferably C1 to C30, more preferably C1 to C20, and further preferably C1 to C12. The organic group, as R⁶ and R⁷, is particularly preferably, any of an organic group having (I) a hydrogen atom; (II) an organic group containing a carboxyl group or a salt form thereof ; (III) an organic group containing a sulfonic acid group or a salt form thereof; (IV) an organic group containing a hydroxyl group; and (V) an organic group containing an amino group.

A preferable embodiment of R⁶ and R⁷ in the above formula (4) includes the case where both of them are organic groups, however, both of R⁶ and R⁷ may take an embodiment of a hydrogen atom at the same time, or the case where one of the R⁶ and R⁷ is a hydrogen atom and the other is an organic group may also be preferable.

The carboxyl group in the above (II) or the sulfonic acid group in the above (III) may be a salt form represented by —COOM¹ or —SO₃M¹, respectively. In this case, M¹ is preferably an alkali metal, an alkaline earth metal, ammonium, an organic ammonium or the like. The alkali metal includes, for example, sodium, lithium, potassium, rubidium, cesium, and the alkaline earth metal includes, for example, magnesium, calcium, strontium, or barium or the like. As the organic ammonium, for example, an alkyl amine such as monoethylamine, diethylamine, or triethylamine; an alkanol amine such as monoethanol amine, diethanol amine, or trietanol amine; an ammonium derived from a polyamine such as ethylene diamine, triethylene diamine is preferable.

As the organic group in the above-described (II) to (V), a straight chained, branched or cyclic hydrocarbon group having C1 to C30 is preferable; C1 to C20 is more preferable, and C1 to C12 is most preferable. A specific example of such an organic group includes a straight chained, branched or cyclic alkyl group having C1 to C30, such as a methyl group, an ethyl group, a propyl group, a butyl group, a (C6 to C20) aryl group such as a phenyl group, a benzyl group.

Therefore, preferable embodiments of R⁶ and R⁷ in the formula (4) include groups shown by the following formulae (i) to (ix):

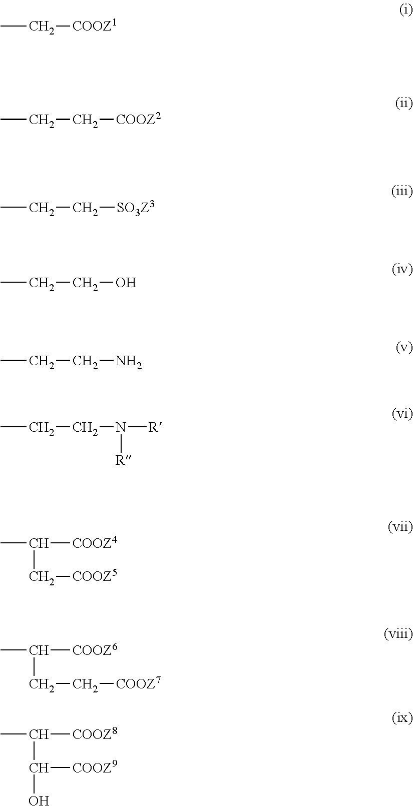

In the above formulae (i) to (ix), Z¹ to Z⁹ represent a hydrogen atom, an alkali metal, an alkaline earth metal, ammonium, or an organic ammonium. In this case, Z¹ to Z⁹ may be the same or different. In addition, in the case where Z¹ to Z⁹ are an alkali metal, an alkaline earth metal, ammonium, or an organic ammonium, the above (i) to (ix) represent salts. Note that an amino group in the above general formula (vi) may take a quaternary form. Preferable examples of the alkali metal, alkaline earth metal, and organic ammonium are the same as those described above, therefore detailed explanation is omitted here.

R′ and R″ may be the same as R⁶ or R⁷ in the formula (4). Or R′ and R″ represent a (C1 to C12) alkyl group or aryl group, or a (C3 to C12) cycloalkyl group. R′ and R″ may be the same or different. The (C1 to C12) alkyl group includes a straight chained or branched alkyl group such as a methyl group, an ethyl group, a n-propyl group, an iso-propyl group, a n-butyl group, an iso-butyl group, a sec-butyl group, a tert-butyl group, a n-pentyl group, a n-hexyl group, a cyclohexyl group, a n-heptyl group, a n-octyl group, a 2-ethylhexyl group, an aryl group includes a phenyl group, a benzyl group, a phenethyl group, o-, m- or p-toly group, 2,3- or 2,4-xylyl group, a mesityl group, a naphthyl group, an anthryl group, a phenanthryl group, a biphenylyl group, a benzhydryl group, a trityl group, and a pyrenyl group or the like, the (C3 to C12) cycloalkyl group includes a cyclopropyl group, a cyclobutyl group, a cyclopentyl group, a cyclohexyl group, a cycloheptyl group, and a cyclooctyl group or the like.

The unsaturated monomer (D-2) used in the present embodiment is represented by the above formula (4), however, preferably the unsaturated monomer (D-2) is a monomer obtainable by the addition of iminodiacetic acid (IDA) to allyl glycidyl ether (AGE), and represented by the following formula:

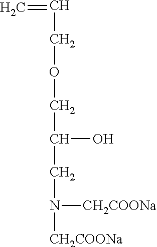

or a monomer obtainable by the addition of diethanol amine (DEA) to allyl glycidyl ether (AGE), and represented by the following formula:

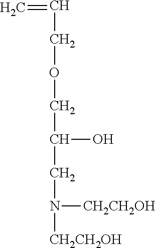

Content of each repeating unit in the (meth)acrylic acid-based copolymer of the present embodiment is not especially limited, however, preferably as follows.

Namely, content of the above repeating unit (a) is preferably equal to or more than 70% by mole and less than 95% by mole, and total content of the above repeating units (b) and (c) is preferably over 0% by mole and equal to or less than 50% by mole, and content of the above repeating unit (d-2) is preferably equal to or more than 5% by mole and less than 30% by mole, based on the total content of the repeating units (a) to (d-2), as 100% by mole. In addition, content of the above repeating unit (a) is more preferably 73 to 95% by mole, further preferably 76 to 92% by mole, and most preferably 80 to 90% by mole. In addition, total content of the above repeating units (b) and (c) is more preferably 2 to 40% by mole, further preferably 2 to 30% by mole, and most preferably 2 to 20% by mole. In addition, content of the above repeating unit (d-2) is more preferably 5 to 25% by mole, further preferably 5 to 20% by mole, and most preferably 5 to 15% by mole. Here, critical significance of numerical range of the contents of the repeating units (a), (b) and (c) is the same as in the above-described first embodiment, and critical significance of numerical range of the contents of the repeating units (d-2) is the same as (d-1) in the above-described first embodiment, therefore, detailed explanation is omitted here.

The (meth)acrylic acid-based copolymer of the present embodiment also may further contain, similarly as in the above-described first embodiment, the repeating unit (e) derived from the other monomer (E). Specific embodiment of the monomer (E) and the repeating unit (e) in the present embodiment is the same as in the above-described first embodiment, therefore, detailed explanation is omitted here. In this case, content of the repeating unit (e) in the copolymer of the present embodiment is not especially limited, however, considering not to inhibit the effect of the repeating units (a), (b), (c) and (d-2), which are essential repeating units, the content of the repeating unit (e) is preferably over 0% by mole and equal to or less than 10% by mole, more preferably over 0% by mole and equal to or less than 7% by mole, and most preferably over 0% by mole and equal to or less than 5% by mole, relative to total content of the repeating units (a), (b), (c) and (d-2), as 100% by mole.

Weight average molecular weight of the (meth)acrylic acid-based copolymer of the present embodiment is not especially limited, and similar embodiment as in the above-described first embodiment may be adopted, therefore, detailed explanation is omitted here.

The (meth)acrylic acid-based copolymer of the present embodiment has a high affinity for a heavy metal ion due to having an amino group derived from the repeating unit (d-2). Consequently, the (meth)acrylic acid-based copolymer of the present embodiment is preferable in terms of excelling in prevention capability of deposition of iron soil, stabilization capability of hydrogen peroxide in the presence of a heavy metal, and detergency in the presence of a heavy metal or a dye, as well as the removing capability of hydrophobic soil and prevention capability of soil redeposition.

### The Third Embodiment

In the present embodiment, the repeating unit (d) is the repeating unit (d-3). Namely, the monomer (D) is the unsaturated monomer (D-3) represented by the following formula (5):

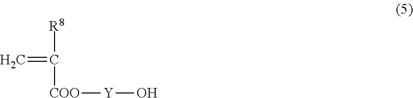

Explanation is given below on repeating units contained in the (meth)acrylic acid-based copolymer of the present embodiment, however, specific embodiments of the repeating unit (a), the repeating unit (b), and the repeating unit (c) are the same as in the above first embodiment. Therefore, detailed explanation on them is omitted here.

(Repeating Unit (d-3))

The repeating unit (d-3) is derived from the hydroxyalkyl(meth)acrylate-based monomer (D-3) represented by the following formula (5):

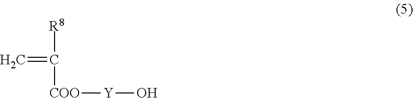

In the present embodiment, the repeating unit (d-3) may be present alone or in a mixture form of two or more kinds. Note that the repeating unit (d-3) becomes a form of (—CH₂—C(R⁸)(COO—Y—OH)—) where a double bond of a vinyl group in the formula (5) is converted to a single bond.

In the above formula (5), R⁸ represents a hydrogen atom or a methyl group.

In the above formula (5), Y represents a (C1 to C4) alkylene group. Such an alkylene group includes, for example, a methylene group, an ethylene group, a trimethylene group, a propylene group, a tetramethylene group, an ethylethylene group, a dimethylethylene group or the like. Among them, Y is preferably an ethylene group, a trimethylene group, a propylene group or tetramethylene group, and more preferably an ethylene group.

The hydroxyalkyl(meth)acrylate-based monomer (D-3) used in the present embodiment is represented by the above formula (5), specifically, includes, for example, 2-hydroxyethyl(meth)acrylate, 2-hydroxypropyl(meth)acrylate, 3-hydroxypropyl(meth)acrylate, 2-hydroxybutyl(meth)acrylate, 4-hydroxybutyl(meth)acrylate, a-hydroxymethylethyl(meth)acrylate or the like. Among these, in a detergent composition application, in view of having affinity to hydrophilic or relatively hydrophilic soil (for example, clay), 2-hydroxyethyl(meth)acrylate (Y is an ehylene group), 2-hydroxypropyl(meth)acrylate (Y is a n-propyl group) is preferably used, and 2-hydroxyethyl(meth)acrylate is particularly preferably used.

Content of each repeating unit in the (meth)acrylic acid-based copolymer of the present embodiment is not especially limited, however, preferably as follows.

Namely, content of the above repeating unit (a) is preferably equal to or more than 30% by mole and less than 95% by mole, and total content of the above repeating units (b) and (c) is preferably over 0% by mole and equal to or less than 50% by mole, and content of the above repeating unit (d-3) is preferably equal to or more than 5% by mole and less than 70% by mole, based on the total content of the repeating units (a) to (d-3), as 100% by mole. In addition, content of the above repeating unit (a) is more preferably 50 to 95% by mole, further preferably 55 to 90% by mole, and most preferably 55 to 85% by mole. In addition, total content of the above repeating units (b) and (c) is more preferably 2 to 40% by mole, further preferably 2 to 30% by mole, and most preferably 2 to 20% by mole. In addition, content of the above repeating unit (d-3) is more preferably 5 to 50% by mole, further preferably 8 to 45% by mole, and most preferably 10 to 40% by mole. Here, critical significance of numerical range of the contents of the repeating units (a), (b) and (c) is the same as in the above-described first embodiment, and critical significance of numerical range of the content of the repeating units (d-3) is the same as (d-1) in the above-described first embodiment, therefore, detailed explanation is omitted here.

The (meth)acrylic acid-based copolymer of the present embodiment also may further contain, similarly as in the above-described first embodiment, the repeating unit (e) derived from the other monomer (E). Specific embodiment of the monomer (E) and the repeating unit (e) in the present embodiment is the same as in the above-described second embodiment, therefore, detailed explanation is omitted here.

Weight average molecular weight of the (meth)acrylic acid-based copolymer of the present embodiment is not especially limited, and similar embodiment as in the above-described first embodiment may be adopted, therefore, detailed explanation is omitted here.

### The Fourth Embodiment

In the present embodiment, the repeating unit (d) is the repeating unit (d-4). Namely, the monomer (D) is the sulfonic acid group containing monomer (D-4) represented by the following formula (6):

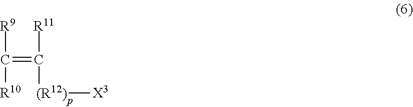

Explanation is given below on repeating units contained in the (meth)acrylic acid-based copolymer of the present embodiment, however, specific embodiments of the repeating unit (a), the repeating unit (b), and the repeating unit (c) are the same as in the above first embodiment. Therefore, detailed explanation on them is omitted here.

(Repeating Unit (d-4))

The repeating unit (d-4) is derived from the sulfonic acid group containing monomer (D-4) represented by the following formula (6):

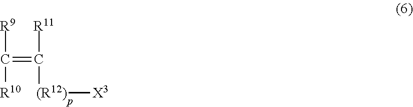

In the present embodiment, the repeating unit (d-4) may be present alone or in a mixture form of two or more kinds. Note that the repeating unit (d-4) becomes a form of (—C(R⁹)(R¹⁰)—C(R¹¹)((R¹²)ₚ—X³)—) where a double bond of a vinyl group in the above formula (5) is converted to a single bond.

In the above formula (6), R⁹, R¹⁰ and R¹¹ may be the same or different and represent a hydrogen atom or a methyl group. Here, all of R⁹, R¹⁰ and R¹¹ preferably take a form of hydrogen atoms (namely, a form having a vinyl group), or R⁹ and R¹⁰ preferably take a form of a hydrogen atom and R¹¹ takes a form of a methyl group (namely, a form having an isopropenyl group), and a form where all of R⁹, R¹⁰ and R¹¹ are hydrogen atoms is more preferable.

In the above formula (6), p represents 0 or 1. In the case where p is 0, X³ , to be described later, directly binds to a carbon atom composing a double bond to which R¹¹ binds. On the other hand, as a preferable embodiment, in the case where p is 1, R¹² represents —CH₂—, —CH₂CH₂—, —CH₂—O—CH₂—, —CO—O—CH₂—CH₂— or —CO—NH—C(CH₃)₂—. Among others, —CH₂—O—CH₂— and —CH₂— are preferable, and —CH₂—O—CH₂— is more preferable as R¹².

In the above formula (6), X³ represents —SO₃X⁴ or —CHR¹³—CH₂R¹⁴, and in this case, definition of X⁴ is the same as in X¹ explained in a section of the (meth)acrylic acid-based monomer which forms the repeating unit (a), therefore, detailed explanation is omitted here. However, in the above formula (6), X⁴ is preferably sodium, potassium, ammonium, more preferably sodium. In addition, as a more preferable embodiment, in the case where X³ is —CHR¹³—CH₂R¹⁴, R¹³ and R¹⁴ may be the same or different, and represents —OH or —SO₃X⁴. Among others, X³ is particularly preferably —CH(OH)—CH₂SO₃X⁴ (namely, R¹³ is —OH and R¹⁴ is —SO₃X⁴). In addition, in the case where X³ is —CHR¹³—CH₂R¹⁴, at least one of R¹³ and R¹⁴ is —SO₃X⁴. Namely, the repeating unit (d-4) composing the (meth)acrylic acid-based copolymer of the present embodiment surely has a sulfonic acid (salt) group at the side chain thereof.

The sulfonic acid group containing monomer (D-4), used in the present embodiment, is represented by the above formula (6), specifically, includes vinyl sulfonic acid and a salt thereof, (meth)allyl sulfonic acid and a salt thereof, 3-(meth)allyloxy-2-hydroxypropane sulfonic acid and a salt thereof, (specifically, sodium 3-allyloxy-2-hydroxypropane sulfonate, (HAPS) or the like), 3-(meth)allyloxy-1-hydroxypropane sulfonic acid and a salt thereof, 2-(meth)allyloxyethylene sulfonic acid and a salt thereof, 2-acrylamide-2-methylpropane sulfonic acid and a salt thereof. Among these, in a detergent application, in view of being excellent in storage stability under alkali condition, the monomer (D-4) is preferably (meth)allyl sulfonic acid or sodium 3-allyloxy-2-hydroxypropane sulfonate (HAPS), more preferably sodium 3-allyloxy-2-hydroxypropane sulfonate (HAPS).

Content of each repeating unit in the (meth)acrylic acid-based copolymer of the present embodiment is not especially limited, however, preferably as follows.

Namely, content of the above repeating unit (a) is preferably equal to or more than 70% by mole and less than 95% by mole, and total content of the above repeating units (b) and (c) is preferably over 0% by mole and equal to or less than 50% by mole, and content of the above repeating unit (d-4) is preferably equal to or more than 5% by mole and less than 30% by mole, based on the total content of the repeating units (a) to (d-4), as 100% by mole. In addition, content of the above repeating unit (a) is more preferably 75 to 95% by mole, further preferably 75 to 90% by mole, and most preferably 80 to 90% bymole. In addition, total content of the above repeating units (b) and (c) is more preferably 2 to 40% by mole, further preferably 2 to 30% by mole, and most preferably 2 to 20% by mole. In addition, content of the above repeating unit (d-4) is more preferably 5 to 20% by mole, further preferably 5 to 18% by mole, and most preferably 5 to 15% by mole. Here, critical significance of numerical range of the contents of the repeating units (a), (b) and (c) is the same as in the above-described first embodiment, and critical significance of numerical range of the contents of the repeating units (d-4) is the same as (d-1) in the above-described first embodiment, therefore, detailed explanation is omitted here.

The (meth)acrylic acid-based copolymer of the present embodiment also may further contain, similarly as in the above-described first embodiment, the repeating unit (e) derived from the other monomer (E). Specific embodiment of the monomer (E) and the repeating unit (e) in the present embodiment is the same as in the above-described second embodiment, therefore, detailed explanation is omitted here.

Weight average molecular weight of the (meth)acrylic acid-based copolymer of the present embodiment is not especially limited, and the similar embodiment as in the above-described first embodiment may be adopted, therefore, detailed explanation is omitted here.

The (meth)acrylic acid-based copolymer of the present aspect has been explained above by classification to several embodiments depending on kind of the monomer (D) which forms the repeating unit (d), however, the scope of the (meth)acrylic acid-based copolymer of the present aspect is by no means limited to the above embodiments. For example, as the monomer (D), not only embodiments where only any one of the monomers (D-1) to (D-4) are adopted, resulting in embodiments where only any one of the repeating units (d) is included in the copolymer, but also other embodiments where 2 or more kinds of the monomers (D-1) to (D-4) are adopted, resulting in embodiments where 2 or more kinds of the repeating units (d) are included in the copolymer, may be included in the scope of the (meth)acrylic acid-based copolymer of the present aspect.

The (meth)acrylic acid-based copolymer of the present aspect, as described above, is excellent in detergency against hydrophilic or relatively hydrophilic soil (for example, clay), as well as high removing capability of hydrophobic soil such as collar dirt or greasy dirt, and in prevention capability of soil redeposition, even when washing is carried out under stringent condition such as using small amount of water, owing to introduction effect of the repeating units (c) and (d). Therefore, the copolymer in the present aspect is particularly preferably used for detergent composition.

Specifically, in the case where the copolymer of the present aspect is used in a detergent composition, prevention rate of soil redeposition is equal to or more than 60.9%, more preferably equal to or more than 61.5%, further preferably equal to or more than 62.0%, and most preferably equal to or more than 62.5%. In addition, note that, in the present application, as value of “prevention rate of soil redeposition”, measurement value obtained according to a method described in the Example is adopted.

A method for producing the above-described (meth)acrylic acid-based copolymer of the present aspect is not especially limited, and methods similar to known polymerization methods or modified methods thereof can be used. For example, the above-described (meth)acrylic acid-based copolymer can be produced by copolymerization of the monomer (A), at least one of the monomer (B) and the monomer (C), and the monomer (D), as essential components. In the case where any one kind of the repeating units (d) is desired to be included in the copolymer, any one of the desired kind in the monomers (D-1) to (D-4) may be adopted as the monomer (D) in the monomer components. On the other hand, in the case where 2 or more kinds of the repeating units (d) are desired to be included in the copolymer, 2 or more desired kinds in the monomers (D-1) to (D-4) may be adopted as the monomers (D) in the monomer components. In addition, in copolymerization of these monomer components, the other monomer (E) may further be copolymerized, if necessary.

In such a production method, monomer components may be copolymerized using a polymerization initiator. The copolymerization of the monomer components is preferably carried out by using water in an amount of equal to or more than 50% by mass of a solvent used, and/or in the presence of a chain transfer agent, more preferably by using water in an amount of equal to or more than 50% by mass of a solvent used and in the presence of a chain transfer agent. In this case, use of water in an amount of equal to or more than 50% by mass of a solvent used is advantageous in that it is capable of suppressing amount of an organic solvent to be used in polymerization, and removal of the organic solvent after completion of polymerization becomes easy. In addition, use of a chain transfer agent is advantageous in that it is capable of suppressing excessive increase in molecular weight of the (meth)acrylic acid-based copolymer to be produced, and efficiently producing the (meth)acrylic acid-based copolymer having relatively low molecular weight. In particular, use of sulfurous acid or a sulfite salt as a chain transfer agent is capable of quantitatively introducing a sulfonic acid group at the terminal of the resultant (meth)acrylic acid-based copolymer, as described later in detail; it is capable of improving anti-gelling property.

Namely, the second aspect of the present invention is a method for producing a (meth)acrylic acid-based copolymer comprising the step for carrying out polymerization of monomer components comprising;
a (meth)acrylic acid-based monomer (A) represented by the following formula (1):

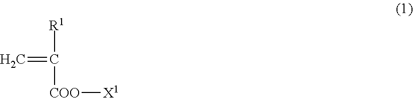

wherein R¹ represents a hydrogen atom or a methyl group, and X¹ represents a hydrogen atom, a metal atom, an ammonium group or an organic amine group; and
an alkyl(meth)acrylate-based monomer (B) represented by the following formula (2):

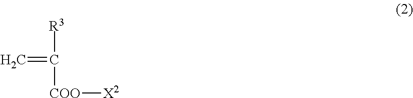

wherein R³ represents a hydrogen atom or a methyl group, and X² represents a (C1 to C12) alkyl group or a (C3 to C12) cycloalkyl group or a (C5 to C12) hydroxyalkyl group; or a vinyl aromatic-based monomer (C); and
one or, 2 or more kinds of monomers (D) selected from the group consisting of:
an unsaturated monomer (D-1) represented by the following formula (3):

R⁴—O-(AO)ₙ—R⁵ (3)

wherein R⁴ represents a (C2 to C5) alkenyl group; AO may be the same or different and represents a group derived from a (C2 to C20) alkylene oxide; R5 represents a hydrogen atom or a (C2 to C5) alkyl group; and n is an integer of 1 to 200; an unsaturated monomer (D-2) represented by the following formula (4):

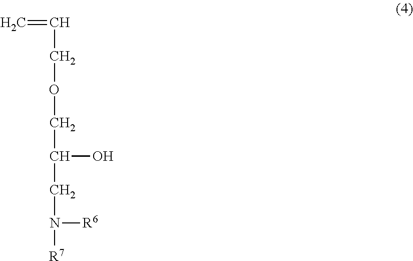

wherein R⁶ and R⁷ may be the same or different and represent a hydrogen atom or an organic group;
a hydroxyalkyl(meth)acrylate-based monomer (D-3) represented by the following formula (5):

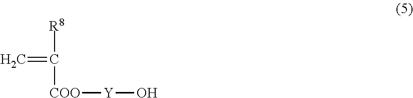

wherein R⁸ represents a hydrogen atom or a methyl group, and Y represents a (C1 to C4) alkylene group; and
a sulfonic acid group containing monomer (D-4) represented by the following formula (6):

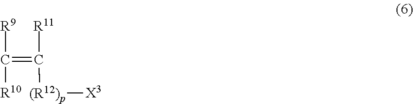

wherein R⁹, R¹⁰ and R¹¹ may be the same or different and represent a hydrogen atom or a methyl group, p represents 0 or 1, provided that when p is 1, R¹² represents —CH₂—, —CH₂—CH₂—, —CH₂—O—CH₂—, —CO—O—CH₂—CH₂—, or —CO—NH—C(CH₃)₂—, and X³ represents —SO₃X⁴ or —CHR¹³—CH₂R¹⁴, and in this case, X⁴ has the same definition as in X¹ in the above formula (1), and R¹³ and R¹⁴ may be the same or different and represent —OH or —SO₃X⁴, and at least one of R¹³ and R¹⁴ represents —SO₃X⁴,
in a solvent comprising water in an amount of equal to or more than 50% by mass, and in the presence of a chain transfer agent.

A production method of the present aspect is explained in detail below, however, the method is by no means limited to the following embodiments.

A production method of the present aspect contains the step for polymerization of monomer components. The monomer components contain the monomer (A), the monomer (B), the monomer (C), and the monomer (D), as essential components, and further contains the monomer (E), if necessary. Here, specific form of each monomer contained in the monomer components is as explained in the section of the first aspect of the present invention; therefore, detailed explanation is omitted here.

Content of each monomer in the monomer components is not especially limited, and can be determined, as appropriate, depending on composition of the (meth)acrylic acid-based copolymer which is desirably produced. Preferable forms of the content of each monomer in the monomer components is explained by referring to each embodiment of the above-described first aspect of the present invention, however, the present invention is by no means limited to the following embodiments.

In producing the (meth)acrylic acid-based copolymer of the above-described first embodiment, content of the monomer (A) is preferably equal to or more than 10% by mass and less than 95% by mass, more preferably equal to or more than 30% by mass and less than 95% by mass, further preferably 35 to 90% by mass, particularly preferably 35 to 85% by mass and most preferably 40 to 80% by mass, based on total content of the monomer (A), the monomer (B), the monomer (C), and the monomer (D), as 100% by mass. Similarly, total content of the monomer (B) and the monomer (C) is preferably over 0% by mass and less than 50% by mass, more preferably 1 to 40% by mass, further preferably 2 to 35% by mass, and most preferably 3 to 30% by mass. Similarly, content of the monomer (D-1) is preferably equal to or more than 5% by mass and less than 90% by mass, more preferably equal to or more than 5% by mass and less than 70% by mass, further preferably 6 to 65% by mass, particularly preferably 8 to 60% by mass and most preferably 10 to 55% by mass. In addition, content of the monomer (E), in the case where the monomer (E) is included in the monomer components, is preferably over 0% by mass and equal to or less than 10% by mass, more preferably over 0% by mass and equal to or less than 7% by mass, and further preferably over 0% by mass and equal to or less than 5% by mass.

In producing the (meth)acrylic acid-based copolymer of the above-described second embodiment, content of the monomer (A) is preferably equal to or more than 50% by mole and less than 95% by mole, more preferably equal to or more than 70% by mole and less than 95% by mole, further preferably 73 to 95% by mole, particularly preferably 76 to 92% by mole and most preferably 80 to 90% by mole, based on total content of the monomer (A), the monomer (B), the monomer (C), and the monomer (D), as 100% by mole. Similarly, total content of the monomer (B) and the monomer (C) is preferably over 0% by mass and less than 50% by mole, more preferably 2 to 40% by mole, further preferably 2 to 30% by mole, and most preferably 2 to 20% by mole. Similarly, content of the monomer (D-2) is preferably equal to or more than 5% by mole and less than 50% by mole, more preferably equal to or more than 5% by mole and less than 30% by mole, further preferably 5 to 25% by mole, particularly preferably 5 to 20% by mole and most preferably 5 to 15% by mole. In addition, content of the monomer (E), in the case where the monomer (E) is contained in the monomer components, is preferably over 0% by mole and equal to or less than 10% by mole, more preferably over 0% by mole and equal to or less than 7% by mole, and further preferably over 0% by mole and equal to or less than 5% by mole.

In producing the (meth)acrylic acid-based copolymer of the above-described third embodiment, content of the monomer (A) is preferably equal to or more than 30% by mole and less than 95% by mole, more preferably 50 to 95% by mole, further preferably 55 to 90% by mole, particularly preferably 55 to 85% by mole, based on total content of the monomer (A), the monomer (B), the monomer (C), and the monomer (D), as 100% by mole. Similarly, total content of the monomer (B) and the monomer (C) is preferably over 0% by mole and less than 50% by mole, more preferably 2 to 40% by mole, further preferably 2 to 30% by mole, and most preferably 2 to 20% by mole. Similarly, content of the monomer (D-3) is preferably equal to or more than 5% by mole and less than 70% by mole, more preferably equal to or more than 5% by mole and less than 50% by mole, further preferably 8 to 45% by mole, and most preferably 10 to 40% by mole. In addition, content of the monomer (E), in the case where the monomer (E) is contained in the monomer components, is preferably over 0% by mole and equal to or less than 10% by mole, more preferably over 0% by mole and equal to or less than 7% by mole, and further preferably over 0% by mole and equal to or less than 5% by mole.

In producing the (meth)acrylic acid-based copolymer of the above-described fourth embodiment, content of the monomer (A) is preferably equal to or more than 50% by mole and less than 95% by mole, more preferably equal to or more than 70% by mole and less than 95% by mole, further preferably 75 to 95% by mole, particularly preferably 75 to 90% by mole, and most preferably 80 to 90% by mole, based on total content of the monomer (A), the monomer (B), the monomer (C), and the monomer (D), as 100% by mole. Similarly, total content of the monomer (B) and the monomer (C) is preferably over 0% by mole and less than 50% by mole, more preferably 2 to 40% by mole, further preferably 2 to 30% by mole, and most preferably 2 to 20% by mole. Similarly, content of the monomer (D-4) is preferably equal to or more than 5% by mole and less than 50% by mole, more preferably equal to or more than 5% by mole and less than 30% by mole, further preferably 5 to 20% by mole, particularly preferably 5 to 18% by mole, and most preferably 5 to 15% by mole. In addition, content of the monomer (E), in the case where the monomer (E) is contained in the monomer components, is preferably over 0% by mole and equal to or less than 10% by mole, more preferably over 0% by mole and equal to or less than 7% by mole, and further preferably over 0% by mole and equal to or less than 5% by mole.

As above, preferable embodiments of the content of each monomer in the monomer components were explained depending on each embodiment of the first aspect of the present invention, however, critical significance of numerical range of the content of each monomer is the same as the numerical range of each repeating unit in the above-described first embodiment, therefore, detailed explanation is omitted here. In addition, in the case where 2 or more kinds are adopted from the monomers (D-1) to (D-4), as the monomer (D) in the monomer components, content of each monomer in the monomer components can be determined, as appropriate, based on the above-described specific numerical range.

A solvent used in the production method in the present aspect is not especially limited as long as it is one containing water in a ratio of equal to or more than 50% by mass, based on total mass of a solvent used. In view of improvement of solubility of monomers used in polymerization into a solvent, an organic solvent may be added, if necessary. Even in this case, content of water in total mixed solvent is equal to or more than 50% by mass. In this case, an organic solvent which can be usable here includes lower alcohols such as methanol, ethanol, or isopropyl alcohol; lower ketones such as acetone, methyl ethyl ketone, diethyl ketone; ethers such as dimethyl ether, dioxane; an amide like dimethylformamide or the like. These solvents may be used alone or in a mixture form of two or more kinds. In the present aspect, content of water i s preferably equal to or more than 80% by mass relative to total mass of a solvent used, and use of only water (namely, 100% by mass) is most preferable.

In the production method of the present aspect, use of an initiator is essential. As the initiator, a known one may be used, for example, hydrogen peroxide; a persulfate such as sodium persulfate, potassium persulfate, ammonium persulfate; an azo-based compound such as 2,2′-azobis(2-amidinopropane)hydrochloride, 4,4′-azobis-4-cyanovaleric acid, azobisisobutyronitrile, 2,2′-azobis(4-methoxy-2,4-dimethylvaleronitrile); an organic peroxide such as benzoyl peroxide, lauroyl peroxide, peracetic acid, di-t-butyl peroxide, cumene hydroperoxide is more preferable; hydrogen peroxide, persulfate is more preferable, and persulfate is most preferable. These initiators may be used alone or in a mixture form of two or more kinds.

Use amount of the initiator is not especially limited, however, preferably equal to or less than 10 g, and more preferably 1 to 5 g, relative to 1 mole of total monomer components composed of the monomers (A), (B), (C), and (D), along with the other monomer (E), if necessary.

In the production method of the present aspect, copolymerization is carried out in the presence of a chain transfer agent. A chain transfer agent which may be used here is not especially limited, as long as it is a compound capable of adjusting molecular weight, and a known chain transfer agent may be used. As a chain transfer agent, specifically, a thiol-based chain transfer agent such as mercaptoethanol, thioglycerol, thioglycolic acid, 2-mercaptopropionic acid, 3-mercaptopropionic acid, thiomalic acid, octyl thioglycolate, octyl 3-mercaptopropionate, 2-mercaptoethane sulfonic acid, n-dodecyl mercaptan, octyl mercaptan, butyl thioglycolate; a halide such as carbon tetrachloride, methylene chloride, bromoform, bromotrichloroethane; a secondary alcohol such as isopropanol, glycerin; a lower oxide and a salt thereof such as phosphorous acid, hypophosphorous acid, and a salt thereof (sodium hypophosphite, potassium hypophosphite or the like), sulfurous acid, sulfurous hydrogen acid, dithionous acid, metabisulfurous acid, and a salt thereof (sodium bisulfite, potassium bisulfite, sodium dithionite, potassium dithionite, sodium metabisulfite, potassium metabisulfite or the like is included. The above-described chain transfer agent may be used alone or in a mixture form of two or more kinds. Among these, in copolymerization relevant to the present embodiment, use of sulfurous acid or a sulfite salt is preferable. Use thereof is capable of quantitatively introducing a sulfonic acid group at the main chain terminal of the resultant (meth)acrylic acid-based copolymer, and improving anti-gelling property. Capability of quantitatively introducing a sulfonic acid group represents very good functioning of a sulfite salt as a chain transfer agent, which is capable of eliminating necessity of the addition of excessive amount of a chain transfer agent to a polymerization reaction system, resulting in suppression of increased cost of copolymer production, as well as improvement of production efficiency, along with sufficiently reducing impurity substances. In addition, the addition of a sulfite salt to a polymerization reaction system is capable of suppressing unnecessary increase in molecular weight of the resulting copolymer.

In the production method of the present aspect, as described above, sulfurous acid and/or a sulfite salt (hereinafter referred to simply as “sulfurous acid (salt)”) are preferably included as a chain transfer agent. The sulfurous acid (salt) represents sulfurous acid or hydrogen sulfurous acid or salts thereof, and a salt form of sulfurous acid/hydrogen sulfurous acid is preferable. In the case where sulfurous acid/hydrogen sulfurous acid is a salt, a salt of a metal atom, ammonium or an organic ammonium is preferable in addition to the above-described examples. As the above-described metal atom, an alkali metal such as lithium, sodium, potassium; an alkaline earth metal such as calcium, magnesium; a trivalent metal atom such as aluminium, iron is preferable. In addition, an alkanol amine such as ethanol amine, diethanol amine, triethanol amine, triethyl amine is preferable as an organic ammonium (organic amine), and further it may be ammonium. Therefore, in the present invention, as a preferably used sulfite, for example, sodium bisulfite, potassium bisulfite, ammonium bisulfite, sodium sulfite, potassium sulfite, ammonium sulfite or the like is included, and sodium bisulfite is particularly preferable. The above-described sulfurous acid (salt) may be used alone or in a mixture form of two or more kinds.

In the production method of the present aspect, the addition amount of a chain transfer agent is not especially limited, as long as it is the amount to provide good polymerization of the monomers (A), (B), (C), and (D), along with other monomer (E), if necessary, however, preferably 1 to 20 g, more preferably 2 to 15 g, relative to 1 mole of total monomer components composed of the monomers (A), (B), (C), and (D), along with other monomer (E), if necessary. Too low amount of the addition of the chain transfer agent could inhibit, quantitative introduction of a sulfonic acid group at the main chain terminal of the resultant copolymer, and control of molecular weight. On the other hand, too high amount of the addition of the chain transfer agent generates much amount of impurity substances, and could reduce the polymer purity, in particular, when a sulfite salt is used, excess sulfite salts are decomposed in a reaction system to generate sulfonic acid gas and could economically be disadvantageous.

In the production method of the present aspect, polymerization may be carried out in the presence of a heavy metal ion as a reaction accelerator. “A heavy metal ion” that may be used as a reaction accelerator represents a metal having a specific gravity of equal to or more than 4 g/cm³. As the above-described metal ion, for example, an ion of iron, cobalt, manganese, chromium, molybdenum, tungsten, copper, silver, gold, lead, platinum, iridium, osmium, palladium, rhodium, ruthenium or the like is preferable. These heavy metal ions may he used as one kind alone or two or more kinds in combination. Among these, iron is more preferable. Ionic valency of the above-described heavy metal ions is not especially limited, and in the case where iron ion is used as the heavy metal ion, the iron ion as the reaction accelerator may be any of Fe²⁺, Fe³⁺ or a combination thereof.

A heavy metal ion as the above-described reaction accelerator is not especially limited, as long as it is included as an ion form, and a method for using a solution dissolved with a heavy metal compound is preferable due to excellent handling. The heavy metal compound used in this case may be any one as long as it contains a desired heavy metal ion, and may be determined as appropriate. In the case where iron is used as the heavy metal ion, use of a heavy metal compound such as Mohr's salt (Fe(NH₄)₂(SO₄)₂.6H₂O) ferrous sulfate heptahydrate, ferrous chloride, ferric chloride or the like is preferable. In addition, in the case where manganese is used as the heavy metal ion, manganese chloride or the like may preferably be used. In the case where these heavy metal compounds are used, because any of them is water-soluble compound, they can be used in a form of an aqueous solution and thus excellent in handling. In addition, a solvent of a solution obtainable by dissolving the above-described heavy metal compound is not limited to water, any one may be used as long as it does not interfere a polymerization reaction in the production method of the present aspect and dissolves the heavy metal compound.

The amount of the heavy metal ion, in the case where the heavy metal ion is used as the reaction accelerator, is not especially limited, it is preferably contained in a catalytic amount at the polymerization step in the present embodiment. “The catalytic amount” referred to in the present invention represents the amount to act as a catalyst without incorporated in the final objective substance, and specifically, it is equal to or less than 100 ppm, preferably equal to or less than 10 ppm, and more preferably equal to or less than 5 ppm.

In addition, content of the heavy metal ion is preferably 0.1 to 10 ppm by mass relative to total mass of a polymerization reaction solution at the completion of a polymerization reaction. Content of the heavy metal ion less than 0.1 ppm by mass is not capable of exerting sufficient effect by the heavy metal ion. On the other hand, content of the heavy metal ion over 10 ppm by mass could incur deterioration of color tone of the resultant polymer. In addition, higher content of the heavy metal ion causes soil of a detergent builder, in the case where the product polymer is used as a detergent builder. Note that the “completion time of a polymerization reaction” represents the time when a polymerization reaction is substantially completed in a polymerization reaction solution, and a desired polymer is obtained. For example, in the case where the resultant polymer is subjected to neutralization with an alkaline component in a polymerization reaction solution, content of the heavy metal ion is calculated based on total mass of the polymerization reaction solution after neutralization. In the case where two or more kinds of heavy metal ions are included, total mass of the heavy metal ions maybe in the above-described range.

As a combination of the above-described initiator and a chain transfer agent, use of each one or more kinds of a persulfate salt and a sulfite salt is most preferable. In this case, use of 0.5 to 5 parts by mass of a sulfite salt, relative to 1 part by mass of a persulfate salt is preferable, more preferably 1 to 4 parts by mass, further preferably 2 to 3 parts by mass. The amount of a sulfite salt less than 0.5 parts by mass could increase total content of an initiator in making low molecular weight, while the amount over 5 parts by mass could increase impurities caused by side reactions.

As a specific example of a combination of the above-described chain transfer agent, initiator and reaction accelerator, a form such as sodium bisulfite(SBS)/hydrogen peroxide(H₂O₂), sodium bisulfite(SBS)/sodium persulfate(NaPS), sodium bisulfite(SBS)/Fe, sodium bisulfite(SBS)/hydrogen peroxide(H₂O₂)/Fe, sodium bisulfite(SBS)/sodium persulfate(NaPS)/Fe, sodium bisulfite(SBS)/sodium persulfate(NaPS)/hydrogen peroxide(H₂O₂), sodium bisulfite(SBS)/oxygen/Fe is preferable. Sodium bisulfite(SBS)/sodium persulfate(NaPS), or sodium bisulfite(SBS)/sodium persulfate(Naps)/Fe is more preferable, sodium bisulfite(SBS)/sodium persulfate(NaPS)/Fe is most preferable.

Total use amount of the above-described chain transfer agent, initiator and reaction accelerator is preferably 2 to 20 g, more preferably is 4 to 18 g and further preferably is 6 to 15 g, relative to 1 mole of the total monomer components composed of the monomers (A), (B), (C), and (D), along with other monomer (E), if necessary. Use amount within such a range is capable of improving production efficiency of production method of the present aspect. In addition, the molecular weight distribution of the (meth)acrylic acid-based copolymer obtained can be provided as desired.

As a method for addition of the above-described polymerization initiator and chain transfer agent into a reactor, a continuous feeding method such as dropping and partitioned feeding maybe applied. In addition, the chain transfer agent may be introduced into a reactor alone or by mixing in advance with each of monomers (A) to (D) or the other monomer (E), which composes the monomer components, a solvent or the like.

In the production method of the present aspect, the method for the addition of the monomer components or polymerization initiator or the like into a reactor includes the following ones as preferable; a method for carrying out copolymerization by feeding all of the monomer components into a reactor and by adding the polymerization initiator into a reactor; a method for carrying out copolymerization by feeding a part of the monomer components into a reactor and by continuously or stepwise (preferably continuously) adding the polymerization initiator and the rest of the monomer components into a reactor; a method for carrying out copolymerization by feeding a polymerization solvent into a reactor and by adding all of the monomer components and the polymerization initiator into a reactor; a method for carrying out copolymerization by feeding a part of 1 monomer (for example the monomer (B)) among the monomers (A) to (D) into a reactor, and by adding the polymerization initiator and the rest of the monomer components (the rest of the monomer (B) and all of the monomers (A), (C) and (D), along with the other monomer (E), if necessary) into a reactor (preferably continuously). Among these methods, a copolymerization method by sequential dropping method of the polymerization initiator and the monomer components into a reactor is preferable because of capability of providing sharp molecular weight distribution of the resultant copolymer, and improved dispersibility when used as a detergent builder.

The copolymerization form is not especially limited, for example, a method usually used such as solution polymerization, bulk polymerization, suspension polymerization, emulsion polymerization or the like may be adopted. Among others, solution polymerization is preferable. A solvent which can be used here, as described above, a mixed solvent containing water in an amount of 50% by mass relative to total solvent, or water is preferable. Use of water only is preferable in view of enabling to eliminate the step for removing a solvent.

The copolymerization method may be carried out in a batch system or a continuous system. In addition, in the copolymerization, as a solvent used as appropriate, a known one may be used, for example, water; alcohols such as methyl alcohol, ethyl alcohol, isopropyl alcohol; glycerin; polyethylene glycol; aromatic or an aliphatic hydrocarbons such as benzene, toluene, xylene, cyclohexane, or n-heptane; esters like ethyl acetate or the like; ketones such as acetone, methyl ethyl ketone; amides like dimethylformamide or the like; ethers such as diethyl ether, dioxane is preferable. These may be used alone or in a mixture form of two or more kinds. Among these, use of one kind or two kinds or more solvents selected from the group consisting of water and lower (C1 to C4) alcohols is preferable in view of solubility of the monomer components and the resultant copolymer.

Use amount of the above-described solvent is not especially limited, however, preferably 40 to 200% by mass, more preferably 45 to 180% by mass, and further preferably 50 to 150% by mass, relative 100% by mass of the monomer components. Use amount of the solvent less than 40% by mass could provide high molecular weight of the resultant copolymer, while use amount over 200% by mass could lower concentration of the resultant copolymer, requiring solvent removal. In addition, a part of or the total of the solvent may be charged into a reactor at the initial stage of polymerization, however, a part of the solvent may be added (dropped) into a reaction system during a polymerization reaction, or may be added (dropped) into a reaction system, in a form of a solvent dissolved with the monomer components or the initiator or the like in advance, namely with these components during a polymerization reaction.

In the production method of the present aspect, copolymerization condition such as copolymerization temperature or the like may be determined as appropriate depending on a copolymerization method, a solvent, a polymerization initiator to be used. For example, copolymerization temperature is preferably 0 to 150° C., more preferably 40 to 120° C., and further preferably 60 to 110° C. In particular, in the case where a sulfurous acid (salt) is used, copolymerization temperature is usually 60° C. to 95° C., preferably 70° C. to 95° C., and further preferably 80° C. to 95° C. In this case, the temperature lower than 60° C. could generate high amount of impurity substances derived from the sulfurous acid (salt). On the contrary, the temperature over 95° C. could emit toxic sulfurous acid gas.

The copolymerization temperature may not necessarily be maintained nearly constant always during a polymerization reaction, and for example, polymerization may be started at room temperature and then the temperature may be raised to set temperature by preferable temperature rising time or temperature rising speed, and may be maintained at the set temperature hereinafter, the temperature may be varied (increase or decrease) with time during a polymerization reaction in accordance with a dropping method of the monomer components, the initiator, or the like.

The copolymerization time is preferably 30 to 300 minutes, more preferably 60 to 240 minutes, and further preferably 120 to 180 minutes.

As pressure in a reaction system in the copolymerization method, any of under normal pressure (atmospheric pressure), under reduced pressure, or under pressure may be included. It is preferable that copolymerization is carried out under normal pressure or under pressure in a closed reaction system, in view of molecular weight of the resultant copolymer. In addition, it is preferable that copolymerization is carried out under normal pressure (atmospheric pressure), in view of facility such as pressurization equipment or depressurization equipment, pressure-proofing reactor, piping or the like. Atmosphere in a reaction system may be air atmosphere; however, inert atmosphere is preferable. For example, purging inside the system with inert gas such as nitrogen or the like before the start of polymerization is preferable.

The reaction solution in the copolymerization preferably has pH in acidic range. In particular, in the case where persulfate and bisulfite are used in combination as the above-described initiator, it is preferable to carryout polymerization in acidic condition. Acidic condition is capable of suppressing increase in viscosity of an aqueous solution of a polymerization reaction system, and copolymer is produced well. In addition, since polymerization reaction proceed under high concentration condition, production efficiency is enhanced significantly to attain a final solid content of equal to or higher than 40%, a total concentration of residual monomers of equal to or lower than 15000 ppm by mass.

The pH of a reaction solution during polymerization is preferably 1 to 6, at 25° C., more preferably 1 to 5, and further preferably 1 to 3.

The resultant copolymer obtained by the above-described copolymerization method may be used, even as it is, as a main component of a detergent composition (a detergent builder) or the like, however, it may be used by further neutralization with an alkaline substance, if necessary. As the alkaline substance, use of an inorganic salt such as hydroxide, chloride, and carbonate or the like of a monovalent metal or a divalent metal; ammonia; an organic ammonium (organic amine) or the like is preferable.

Ratio of neutralization in carrying out copolymerization may be determined as appropriate depending on the kinds of an initiator. For example, in the case where persulfate and bisulfite are used in combination as an initiator, copolymerization may be carried out by setting ratio of neutralization (mole number of monomers forming salts) to be 0 to 60% by mole, more preferably equal to or lower than 50% by mole, further preferably equal to or lower than 40 by mole, further more preferably equal to or lower than 30% by mole, more particularly preferably equal to or lower than 20% by mole, and most preferably equal to or lower than 10% by mole, based on total amount of salt formable monomer, as 100% by mole. The ratio of neutralization of monomers over 60% by mole inhibits to increase polymerization rate in the copolymerization, which could lower molecular weight of the resultant copolymer or lower production efficiency.

As a method for copolymerization by setting the ratio of neutralization of the monomers within the above range, for example, in the case where the monomer is an unsaturated carboxylic acid-based monomer, the following method is preferable: a method for subjecting a totally acid type unsaturated carboxylic acid-based monomer to copolymerization without neutralization; and a method for subjecting the monomer to copolymerization by setting the ratio of neutralization to be 0 to 60% by mole in neutralization of the unsaturated carboxylic acid-based monomer into a salt form such as a sodium salt, an ammonium salt, using an alkaline substance; or the like.

The (meth)acrylic acid-based copolymer of the first aspect of the present invention or the (meth)acrylic acid-based copolymer produced by a production method of the second aspect of the present invention is preferably used in a detergent composition (detergent builder), chemicals for water treatment or chemicals for fiber treatment, a dispersing agent. As detergent applications, the (meth)acrylic acid-based copolymer may be used in various applications including for clothes, for table ware, for housings, for hair, for body, for toothpaste, and for automobile, or the like. As described above, a detergent composition (detergent builder), chemicals for water treatment or chemicals for fiber treatment, and a dispersing agent composed by containing the (meth)acrylic acid-based copolymer provided by the present invention are also included as one of preferable embodiments of the present invention. Therefore, the third aspect of the present invention is a detergent composition containing the (meth)acrylic acid-based copolymer of the first aspect of the present invention or the (meth)acrylic acid-based copolymer produced by a production method of the second aspect of the present invention.

A detergent composition of the present aspect exerts preventive action against re-adhesion of soil to clothes in washing, and may contain a builder for a powder detergent, or may contain a builder for a liquid detergent. In the case where the (meth)acrylic acid-based copolymer prevents re-adhesion of soil, presence of a hydrophobic group derived from the repeating units (b) and (c) contributes to high affinity to hydrophobic soil and exerts action of reducing affinity between clothes and soil. In addition, presence of a hydrophilic group derived from the repeating units (a) and (d) exerts dispersion action of soil. Such interactions to soil vary depending on ionic nature such as anionic or cationic nature, in addition to the above.

A detergent composition of the present aspect is capable of providing a detergent builder having very high quality, performance and stability including excellent prevention capability of soil redeposition, and further prevention of performance deterioration after a long period of storage, or little generation of impurity deposition or the like caused by storing at low temperature. In the case where the (meth)acrylic acid-based copolymer of the present invention is used for a detergent composition, prevention rate of soil redeposition is preferably equal to or more than 60.9%, more preferably equal to or more than 61.5%, further preferably equal to or more than 62.0%, and most preferably equal to or more than 62.5%.

Content of the (meth)acrylic acid-based copolymer in a detergent composition of the present aspect is not especially limited, however, preferably 0.1 to 30% by mass, more preferably 0.1 to 20% by mass and further preferably 0.1 to 10% by mass, relative to the detergent composition as 100% by mass. Too low content of the copolymer in a detergent composition could provide insufficient cleaning capability, while too high content could be uneconomical.

Components or contents of other compositions than the (meth)acrylic acid-based copolymer in a detergent composition of the present aspect are not especially limited, and may be used as appropriate within a range not impairing action the effect of the present invention, based on various components which may be used in a conventionally known detergent builder and contents thereof.

A detergent composition of the present aspect may be any of a powder type detergent composition or a liquid type detergent composition. In addition, a detergent composition of the present aspect may be added with the additives which can usually be used in a detergent. As the above-described additives, a re-adhesion preventive agent to prevent re-deposition of soil substances such as an alkaline builder, a chelate builder, sodium carboxymethylcellulose, a soil suppressing agent such as benzotriazole, or ethylene thiourea, a soil releasing agent, an inhibitor of color transferring, a softening agent, an alkaline material for pH adjustment, a flavor, a solubilizing agent, a fluorescent agent, a coloring agent, a foaming agent, a foam stabilizer, a glazing agent, a sterilizer, a bleaching agent, a bleaching auxiliary agent, an enzyme, a dye, a solvent or the like is included. In addition, in the case of a powder type detergent composition, zeolite is preferably formulated.

In addition, a detergent composition of the present aspect maybe composed of only the (meth)acrylic acid-based copolymer of the present invention, or may be mixed with other known detergent builders. In addition, if necessary, a form neutralized with an alkaline substance may be used. The above-described detergent builder is not especially limited, for example, includes sodium tripolyphosphate, sodium pyrophosphate, sodium silicate, Glauber's salt, sodium carbonate, sodium nitrilotriacetate, tetrasodium or tetrapotassium ethylenediamine tetraacetate, zeolite, a carboxyl derivative of polysaccharide, a water-soluble polymer such as a (co)poly(meth)acrylate salt, or a (co)polyfumarate salt or the like.

Content of the above-described additives/known detergent builder in a detergent composition of the present embodiment is not especially limited, and preferably 0.1 to 80% by mass, more preferably 0.2 to 70% by mass, further preferably 0.3 to 60% by mass, particularly preferably 0.4 to 50% by mass, and most preferably 0.5 to 40% by mass, relative to 100% by mass of a detergent composition. The content of a known detergent builder in a detergent composition less than 0.1% by mass could provide insufficient performance as a detergent, while the content of a known detergent builder over 20% by mass could become uneconomical.

As a formulation form of the above-described (meth)acrylic acid-based copolymer of the present invention in a detergent composition of the present aspect, any of liquid, solid or the like may be used, and may be determined in accordance with a form of a detergent at the time of sale (for example, a liquid article or a solid article). The detergent composition may be formulated as a form of an aqueous solution after polymerization, or may be formulated as a concentrated state by reducing water content to a certain degree in an aqueous solution, or may be formulated as a solidified state by drying.

In addition, the above-described detergent composition includes not only a synthesis detergent for domestic use, a detergent for other industrial use like in fiber industry or the like, a detergent for hard surface but also a detergent used only in a specific application like a detergent for bleaching with enhanced action of one component thereof.

The above-described surfactant is at least one kind selected from the group consisting of an anionic surfactant, a nonionic surfactant, a cationic surfactant, and an amphoteric surfactant, these surfactants may be used alone or in combination of 2 or more kinds. In the case where 2 or more kinds of surfactants are used, total content of the anionic surfactant and the nonionic surfactant is preferably equal to or more than 50 by mass, more preferably equal to or more than 60% by mass, further preferably equal to or more than 70% by mass, and particularly preferably equal to or more than 80% by mass, relative to total amount of surfactants, as 100% by mass.

The above-described anionic surfactant preferably includes an alkylbenzene sulfonate, an alkylether sulfate, an alkenylether sulfate, an alkyl sufate, an alkenyl sulfate, an a-olefin sulfonate, an a-sulfo aliphatic acid or an ester salt thereof, an alkane sulfonate, a saturated aliphatic acid salt, an unsaturated aliphatic acid salt, an alkylether carboxylate, an akenylether carboxylate, an amino acid-based surfactant, an N-acylamino acid-based surfactant, an alkyl phosphate or a salt thereof, an alkenyl phosphate or a salt thereof, or the like.

A hydrogen atom in alkyl group or an alkenyl group in the above anionic surfactant may be substituted with an alkyl group like a methyl group.

The above nonionic surfactant preferably includes a polyoxyalkylene alkyl ether, a polyoxyalkylene alkenyl ether, a polyoxyethylene alkylphenyl ether, a higher aliphatic acid alkanolamide or an alkyleneoxide adduct thereof, an aliphatic acid ester of sucrose, an alkyl glycoside, an aliphatic acid monoester of glycerin, an alkylamine oxide or the like. In the alkyl group or an alkenyl group in the above nonionic surfactant, an alkyl group like a methyl group may be branched.

The above cationic surfactant preferably includes a quaternary ammonium salt or the like.

The above amphoteric surfactant preferably includes a carboxyl-based amphoteric surfactant, a sulfobetaine-based amphoteric surfactant.

A hydrogen atom in the alkyl group or an alkenyl group in the above cationic surfactant or an amphoteric surfactant may be substituted with an alkyl group like a methyl group.

Content of the above-described surfactant in a detergent composition of the present aspect is not especially limited, however, preferably 10 to 60% bymass, more preferably 15 to 50% by mass, further preferably 20 to 45% by mass, and particularly preferably 25 to 40% by mass, relative to a detergent composition, as 100% by mass. The content of the surfactant in a detergent composition less than 10% by mass could not exert sufficient cleaning power, while the content of the surfactant over 60% by mass could become uneconomical.

In the case where the detergent composition of the present aspect is a liquid detergent composition, water amount contained in the liquid detergent composition is not especially limited, however, preferably 0.1 to 75% by mass, more preferably 0.2 to 70% by mass, further preferably 0.5 to 65% by mass, further more preferably 0.7 to 60% by mass, particularly preferably 1 to 55% by mass, and most preferably 1.5 to 50% by mass, relative to the liquid detergent composition, as 100% by mass.

Kaolin turbidity of the above-described liquid detergent composition is not especially limited, however, preferably equal to or less than 200 mg/L, more preferably equal to or less than 150 mg/L, further preferably equal to or less than 120 mg/L, particularly preferably equal to or less than 100 mg/L, and most preferably equal to or less than 50 mg/L.

In addition, variance (difference) in the kaolin turbidity between before and after the (meth)acrylic acid-based copolymer of the present invention is added to a liquid detergent composition as a detergent builder, is preferably equal to or less than 500 mg/L, more preferably equal to or less than 400 mg/L, further preferably equal to or less than 300 mg/L, particularly preferably equal to or less than 200 mg/L, and most preferably equal to or less than 100 mg/L. The kaolin turbidity may be measured, for example, by a measurement method of the kaolin turbidity to be described later.

### (A Measurement Method of the Kaolin Turbidity)

Turbidity (the kaolin turbidity: mg/L) at 25° C. is measured using NDH2000 (trade name; a turbidity meter) manufactured by Nippon Denshoku Ind. Co., Ltd, by feeding a uniformly stirred sample (a liquid detergent) into a 50-mm square cell with a thickness of 10 mm, and then removing air bubbles.

As enzymes which may be formulated in the above-described detergent composition, protease, lipase, cellulase or the like is preferable. Among others, protease, alkaline lipase, and alkaline cellulase having high activity in an alkaline cleaning solution are preferable.

The addition amount of the above-described enzyme is preferably equal to or less than 5% by mass, relative to the detergent composition as 100% by mass. The addition amount over 5% by mass provides no improvement of cleaning capability and thus could become uneconomical.

The above-described alkali builder preferably includes silicate, carbonate, sulfate or the like. The above-described chelate builder preferably includes diglycolic acid, oxycarboxylate, EDTA (ethylene diamine tetraacetic acid), DTPA (diethylene triamine pentaacetic acid), STPP (sodium tripolyphosphate), citric acid, or the like. A water-soluble polycarboxylic acid-based polymer other than the copolymer of the present invention may also be used as the alkali builder.

The above-described (meth)acrylic acid-based copolymer of the present invention is also one capable of exerting dispersing performance or the like, in various applications, and thus preferably be applicable to other applications, for example, chemicals for water treatment, a dispersing agent, chemicals for fiber treatment, a scaling preventive agent (a scaling retarder), a cement additive, a metal ion sealant, a thickening agent, various binders, an emulsifier, a skin care agent, and a hair care agent or the like.

The above-described chemicals for water treatment, for example, may be added to a water system such as a cooling water system, boiler water. In this case, the (meth)acrylic acid-based copolymer may be used as it is, or those containing components other than the (meth)acrylic acid-based copolymer may be added. Components or contents of compositions other than the (meth)acrylic acid-based copolymer in chemicals for water treatment may be adopted, as appropriate, within a range not impairing action effect of the present invention, based on various components which may be used in a conventionally known chemicals for water treatment, and contents thereof.

The above-described dispersing agent may be any one as long as being an aqueous type dispersing agent and, for example, dispersing agents for pigments, cement, calcium carbonate, kaolin or the like are preferable. Dispersing agents like these are capable of exerting very excellent dispersing ability which the (meth)acrylic acid-based copolymer originally has. In addition, a dispersing agent having very high quality, performance and stability including prevention of performance deterioration after a long period of storage, and no generation of impurity deposition or the like by storing at low temperature can be provided. Components or contents of compositions other than the (meth)acrylic acid-based copolymer in dispersing agent may he used, as appropriate, within a range not impairing action effect of the present invention, based on various components which may be used in a conventionally known dispersing agent and contents thereof.

### EXAMPLES

The present invention is explained in further detail by referring to Examples, however, the present invention is by no means limited to these Examples. Note that “parts” represent “parts by mass” and “%” represent “% by mass”, respectively, unless otherwise specified.

In addition, weight average molecular weight and prevention capability of soil redeposition of the (meth)acrylic acid-based copolymer of the present invention were measured according to the following methods:

### (Measurement Conditions of Weight Average Molecular Weight)

Equipment: L-7000 series manufactured by Hitachi Ltd.
Detector: RI
Column: SHODEX Asahipak GF-310-HQ, GF-710-HQ, and GF-1G 7B manufactured by Showa Denko K. K.
Column temperature: 40° C.
Flow rate: 0.5 ml/min
Calibration curve: POLYACRYLIC ACID STANDARD manufactured by Souwa Science Co., Ltd.
Eluting solution: 0.1N sodium acetate/acetonitrile=3/1 (mass ratio)

### (A Measurement Method of Ratio of Prevention Capability of Soil Redeposition)

(1) White cloth was prepared by cutting out polyester cloth purchased from Test Fabric Co., Ltd. to a 5 cm×5 cm size. Degree of whiteness of this white cloth was measured in advance using the colorimetric color difference meter SE2000 model manufactured by Nippon Denshoku Ind. Co., Ltd.
(2) Hard water was prepared by adding deionized water to 4.41 g of calcium chloride dihydrate so as to make 15 kg in total.
(3) An aqueous solution of a surfactant was prepared by adding deionized water to 4.0 g of linear sodium alkylbenzene sulfonate, 6.0 g of sodium carbonate and 2.0 g of sodium sulfate so as to make 100.0 g in total.
(4) “Targot meter” was set at 25° C.; 1 L of hard water, 5 g of the aqueous solution of the surfactant, 1 g of an aqueous solution of a polymer with a solid content of 2%, 0.15 g of zeolite and 0.25 g of carbon black were charged in a pot and stirred for 1 minute at 100 rpm. Subsequently, 10 pieces of the white cloth were stirred therein for 10 minutes at 100 rpm.
(5) Water draining from the cloth by hand, and then putting the cloth into the pot containing 1 L of tapped water at 25° C. and subsequent stirring for 2 minutes at 100 rpm were repeated twice.
(6) Wrinkles on the cloth were stretched with an iron by covering with another cloth, and after drying, degree of whiteness of the white cloth was measured again by the above-described colorimetric color difference meter.
(7) Prevention rate of soil redeposition was determined by the following equation using the above measurement results:

Prevention rate of soil redeposition (%)=[(degree of whiteness after cleaning)/(degree of whiteness of original cloth)]×100 (Expression 1)

### Copolymer of the First Embodiment

### Example 1-1

Into a 2.5-L separable SUS flask equipped with a refluxing condenser and a stirrer, 334.0 g of deionized water and 0.0107 g of Mohr's salt were charged and the solution was heated to 90° C. under stirring to prepare a polymerization reaction system. Then, under stirring, into the polymerization reaction system maintained at 90° C., 437.5 g of an aqueous solution of 80% acrylic acid (hereinafter abbreviated as 80% AA) as an aqueous solution of the monomer (A), 20.3 g of an aqueous solution of 48% sodium hydroxide (hereinafter abbreviated as 48% NaOH), 100.0 g of a isoprenol/ethylene oxide 10 mole adduct (hereinafter abbreviated as 100% IPN10) as the monomer (D-1), 50.0 g of 100% styrene (hereinafter abbreviated as 100% St) as the monomer (C), 110.6 g of an aqueous solution of 15% sodium persulfate (hereinafter abbreviated as 15% NaPS), and 94.8 g of an aqueous solution of 35% sodium bisulfite (hereinafter abbreviated as 35% SBS) were each dropped from a separate nozzle. Dropping time of each solution was 180 minutes for 80% AA and 48% NaOH; 170 minutes for 100% IPN10 and 100% St; 185 minutes for 15% NaPS; and 175 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 372.6 g of 48% NaOH was slowly dropped under stirring to neutralize the polymerization reaction solution. By the above procedure, an aqueous solution of the polymer (1-1) having a solid content of 45% and a weight average molecular weight of 14,000 was obtained. Composition of the repeating units (a), (c) and (d-1) in the resultant polymer (1-1) was 70% by mass, 10% by mass and 20% by mass, respectively.

### Example 1-2

Into a 2.5-L separable SUS flask equipped with a refluxing condenser and a stirrer, 337.0 g of deionized water and 0.0107 g of Mohr's salt were charged and the solution was heated to 90° C. under stirring to prepare a polymerization reaction system. Then, under stirring, into the polymerization reaction system maintained at 90° C., 437.5 g of 80% AA, 20.3 g of 48% NaOH, 125.0 g of 100% IPN10, 25.0 g of 100% St, 106.8 g of 15% NaPS, and 91.5 g of 35% SBS were each dropped from a separate nozzle. Dropping time of each solution was 180 minutes for 80% AA and 48% NaOH; 170 minutes for 100% IPN10 and 100% St; 185 minutes for 15% NaPS; and 175 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 372.6 g of 48% NaOH was slowly dropped under stirring to neutralize the polymerization reaction solution. By the above procedure, an aqueous solution of the polymer (1-2) having a solid content of 45% and a weight average molecular weight of 11,000 was obtained. Composition of the removing capability of hydrophobic soil such as collar dirt or greasy dirt, and in prevention capability of soil repeating units (a), (c) and (d-1) in the resultant polymer (1-2) was 70% by mass, 5% by mass and 25% by mass, respectively.

### Example 1-3

Into a 2.5-L separable SUS flask equipped with a refluxing condenser and a stirrer, 415.0 g of deionized water and 0.0101 g of Mohr's salt were charged and the solution was heated to 90° C. under stirring to prepare a polymerization reaction system. Then, under stirring, into the polymerization reaction system maintained at 90° C., 312.5 g of 80% AA, 14.5 g of 48% NaOH, 150.0 g of 100% IPN10, 100.0 g of 100% St, 94.4 g of 15% NaPS, and 80.9 g of 35% SBS were each dropped from a separate nozzle. Dropping time of each solution was 180 minutes for 80% AA and 48% NaOH; 170 minutes for 100% IPN10 and 100% St; 185 minutes for 15% NaPS; and 175 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 266.1 g of 48% NaOH was slowly dropped under stirring to neutralize the polymerization reaction solution. By the above procedure, an aqueous solution of the polymer (1-3) having a solid content of 45% and a weight average molecular weight of 34,000 was obtained. Composition of the repeating units (a), (c) and (d-1) in the resultant polymer (1-3) was 50% by mass, 20% by mass and 30% by mass, respectively.

### Example 1-4

Into a 2.5-L separable SUS flask equipped with a refluxing condenser and a stirrer, 330.0 g of deionized water and 0.0107 g of Mohr's salt were charged and the solution was heated to 90° C. under stirring to prepare a polymerization reaction system. Then, under stirring, into the polymerization reaction system maintained at 90° C., 437.5 g of 80% AA, 20.3 g of 48% NaOH, 75.0 g of 100% IPN10, 75.0 g of 100% St, 114.5 g of 15% NaPS, and 98.1 g of 35% SBS were each dropped from a separate nozzle. Dropping time of each solution was 180 minutes for 80% AA and 48% NaOH; 170 minutes for 100% IPN10 and 100% St; 185 minutes for 15% NaPS; and 175 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 372.6 g of 48% NaOH was slowly dropped under stirring to neutralize the polymerization reaction solution. By the above procedure, an aqueous solution of the polymer (1-4) having a solid content of 45% and a weight average molecular weight of 17,000 was obtained. Composition of the repeating units (a), (c) and (d-1) in the resultant polymer (1-4) was 70% by mass, 15% by mass and 15% by mass, respectively.

### Example 1-5

Into a 2.5-L separable SUS flask equipped with a refluxing condenser and a stirrer, 352.0 g of deionized water and 0.0105 g of Mohr's salt were charged and the solution was heated to 90° C. under stirring to prepare a polymerization reaction system. Then, under stirring, into the polymerization reaction system maintained at 90° C., 406.3 g of 80% AA, 18.8 g of 48% NaOH, 100.0 g of 100% IPN10, 75.0 g of 100% St, 108.5 g of 15% NaPS, and 93.0 g of 35% SBS were each dropped from a separate nozzle. Dropping time of each solution was 180 minutes for 80% AA and 48% NaOH; 170 minutes for 100% IPN10 and 100% St; 185 minutes for 15% NaPS; and 175 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 345.9 g of 48% NaOH was slowly dropped under stirring to neutralize the polymerization reaction solution. By the above procedure, an aqueous solution of the polymer (1-5) having a solid content of 45% and a weight average molecular weight of 19,000 was obtained. Composition of the repeating units (a), (c) and (d-1) in the resultant polymer (1-5) was 65% by mass, 15% by mass and 20% by mass, respectively.

### Example 1-6

Into a 2.5-L separable SUS flask equipped with a refluxing condenser and a stirrer, 432.0 g of deionized water and 0.0099 g of Mohr's salt were charged and the solution was heated to 90° C. under stirring to prepare a polymerization reaction system. Then, under stirring, into the polymerization reaction system maintained at 90° C., 312.5 g of 80% AA, 14.5 g of 48% NaOH, 225.0 g of 100% IPN10, 25.0 g of 100% St, 82.8 g of 15% NaPS, and 71.0 g of 35% SBS were each dropped from a separate nozzle. Dropping time of each solution was 180 minutes for 80% AA and 48% NaOH; 160 minutes for 100% IPN10 and 100% St; 185 minutes for 15% NaPS; and 175 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 245.8 g of 48% NaOH was slowly dropped under stirring to neutralize the polymerization reaction solution. By the above procedure, an aqueous solution of the polymer (1-6) having a solid content of 45% and a weight average molecular weight of 17,000 was obtained. Composition of the repeating units (a), (c) and (d-1) in the resultant polymer (1-6) was 50% by mass, 5% by mass and 45% by mass, respectively.

### Example 1-7

Into a 2.5-L separable SUS flask equipped with a refluxing condenser and a stirrer, 170.0 g of deionized water and 0.0250 g of Mohr's salt were charged and the solution was heated to 90° C. under stirring to prepare a polymerization reaction system. Then, under stirring, into the polymerization reaction system maintained at 90° C., 300.0 g of 80% AA, 13.9 g of 48% NaOH, 240.0 g of a 50% aqueous solution of isoprenol/ethylene oxide 10 mole adduct (hereinafter abbreviated as 50% IPN10) as an aqueous solution of the monomer (D-1), 40.0 g of 100% St, 100.5 g of 15% NaPS, and 86.2 g of 35% SBS were each dropped from a separate nozzle. Dropping time of each solution was 180 minutes for 80% AA, 48% NaOH and 35% SBS; 60 minutes for 50% IPN10; 120 minutes for 100% St; 210 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 236.1 g of 48% NaOH was slowly dropped under stirring to neutralize the polymerization reaction solution. By the above procedure, an aqueous solution of the polymer (1-7) having a solid content of 45% and a weight average molecular weight of 20,000 was obtained. Composition of the repeating units (a), (c) and (d-1) in the resultant polymer (1-7) was 60% by mass, 10% by mass and 30% by mass, respectively.

### Example 1-8

Into a 2.5-L separable SUS flask equipped with a refluxing condenser and a stirrer, 433.0 g of deionized water and 0.0099 g of Mohr's salt were charged and the solution was heated to 90° C. under stirring to prepare a polymerization reaction system. Then, under stirring, into the polymerization reaction system maintained at 90° C., 312.5 g of 80% AA, 14.5 g of 48% NaOH, 225.0 g of 100% IPN10, 25.0 g of 100% butyl acrylate (hereinafter abbreviated as 100% BA) as the monomer (B), 81.9 g of 15% NaPS, and 70.2 g of 35% SBS were each dropped from a separate nozzle. Dropping time of each solution was 180 minutes for 80% AA and 48% NaOH; 160 minutes for 100% IPN10 and 100% BA; 185 minutes for 15% NaPS; and 175 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 245.8 g of 48% NaOH was slowly dropped under stirring to neutralize the polymerization reaction solution. By the above procedure, an aqueous solution of the polymer (1-8) having a solid content of 45% and a weight average molecular weight of 28,000 was obtained. Composition of the repeating units (a), (b) and (d-1) in the resultant polymer (1-8) was 50% by mass, 5% by mass and 45% by mass, respectively.

### Example 1-9

Into a 2.5-L separable SUS flask equipped with a refluxing condenser and a stirrer, 316.0 g of deionized water and 0.0103 g of Mohr's salt were charged and the solution was heated to 90° C. under stirring to prepare a polymerization reaction system. Then, under stirring, into the polymerization reaction system maintained at 90° C., 468.8 g of 80% AA, 21.7 g of 48% NaOH, 100.0 g of 100% IPN10, 25.0 g of 100% 2-ethylhexyl acrylate (hereinafter abbreviated as 100% EHA) as the monomer (B), 110.7 g of 15% NaPS, and 94.9 g of 35% SBS were each dropped from a separate nozzle. Dropping time of each solution was 180 minutes for 80% AA and 48% NaOH; 170 minutes for 100% IPN10 and 100% EHA; 185 minutes for 15% NaPS; and 175 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 325.7 g of 48% NaOH was slowly dropped under stirring to neutralize the polymerization reaction solution. By the above procedure, an aqueous solution of the polymer (1-9) having a solid content of 45% and a weight average molecular weight of 18,000 was obtained. Composition of the repeating units (a), (b) and (d-1) in the resultant polymer (1-9) was 75% by mass, 5% by mass and 20% by mass, respectively.

### Example 1-10

Into a 2.5-L separable SUS flask equipped with a refluxing condenser and a stirrer, 365.0 g of deionized water and 0.0103 g of Mohr's salt were charged and the solution was heated to 90° C. under stirring to prepare a polymerization reaction system. Then, under stirring, into the polymerization reaction system maintained at 90° C., 437.5 g of 80% AA, 20.3 g of 48% NaOH, 125.0 g of 100% IPN10, 25.0 g of 100% EHA, 104.7 g of 15% NaPS, and 89.7 g of 35% SBS were each dropped from a separate nozzle. Dropping time of each solution was 180 minutes for 80% AA and 48% NaOH; 170 minutes for 100% IPN10 and 100% EHA; 185 minutes for 15% NaPS; and 175 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 304.0 g of 48% NaOH was slowly dropped under stirring to neutralize the polymerization reaction solution. By the above procedure, an aqueous solution of the polymer (1-10) having a solid content of 45% and a weight average molecular weight of 21,000 was obtained. Composition of the repeating units (a), (b) and (d-1) in the resultant polymer (1-10) was 70% by mass, 5% by mass and 25% by mass, respectively.

### Example 1-11

Into a 2.5-L separable SUS flask equipped with a refluxing condenser and a stirrer, 434.0 g of deionized water and 0.0099 g of Mohr's salt were charged and the solution was heated to 90° C. under stirring to prepare a polymerization reaction system. Then, under stirring, into the polymerization reaction system maintained at 90° C., 312.5 g of 80% AA, 14.5 g of 48% NaOH, 225.0 g of 100% IPN10, 25.0 g of 100% EHA, 80.7 g of 15% NaPS, and 69.2 g of 35% SBS were each dropped from a separate nozzle. Dropping time of each solution was 180 minutes for 80% AA, 48% NaOH and 35% SBS; 170 minutes for 100% IPN10 and 100% EHA; and 210 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 245.8 g of 48% NaOH was slowly dropped under stirring to neutralize the polymerization reaction solution. By the above procedure, an aqueous solution of the polymer (1-11) having a solid content of 45% and a weight average molecular weight of 32,000 was obtained. Composition of the repeating units (a), (b) and (d-1) in the resultant polymer (1-11) was 50% by mass, 5% by mass and 45% by mass, respectively.

### Example 1-12

Into a 2.5-L separable SUS flask equipped with a refluxing condenser and a stirrer, 170.0 g of deionized water and 0.0250 g of Mohr's salt were charged and the solution was heated to 90° C. under stirring to prepare a polymerization reaction system. Then, under stirring, into the polymerization reaction system maintained at 90° C., 300.0 g of 80% AA, 13.9 g of 48% NaOH, 240.0 g of an aqueous solution of a 50% aqueous solution of isoprenol/ethylene oxide 50 mole adduct (hereinafter abbreviated as 50% IPN50) as an aqueous solution of the monomer (D-1), 40.0 g of 100% St, 100.5 g of 15% NaPS, and 86.2 g of 35% SBS were each dropped from a separate nozzle. Dropping time of each solution was 180 minutes for 80% AA and 48% NaOH; 60 minutes for 50% IPN50; 120 minutes for 100% St; 210 minutes for 15% NaPS; and 180 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 236.1 g of 48% NaOH was slowly dropped under stirring to neutralize the polymerization reaction solution. By the above procedure, an aqueous solution of the polymer (1-12) having a solid content of 45% and a weight average molecular weight of 18,000 was obtained. Composition of the repeating units (a), (c) and (d-1) in the resultant polymer (1-12) was 60% by mass, 10% by mass and 30% by mass, respectively.

### Example 1-13

Into a 2.5-L separable SUS flask equipped with a refluxing condenser and a stirrer, 310.0 g of deionized water and 0.0106 g of Mohr's salt were charged and the solution was heated to 90° C. under stirring to prepare a polymerization reaction system. Then, under stirring, into the polymerization reaction system maintained at 90° C., 437.5 g of 80% AA, 20.3 g of 48% NaOH, 100.0 g of 100% IPN10, 25.0 g of 100% St, 50.0 g of 50% N-isopropyl acrylamide (hereinafter abbreviated as 50% NIPAM) as an aqueous solution of the monomer (E), 105.8 g of 15% NaPS, and 90.7 g of 35% SBS were each dropped from a separate nozzle. Dropping time of each solution was 180 minutes for 80% AA and 48% NaOH; 170 minutes for 100% IPN10, 100% St, and 50% NIPAM; 185 minutes for 15% NaPS; and 175 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 372.6 g of 48% NaOH was slowly dropped under stirring to neutralize the polymerization reaction solution. By the above procedure, an aqueous solution of the polymer (1-13) having a solid content of 45% and a weight average molecular weight of 13,000 was obtained. Composition of the repeating units (a), (c), (d-1) and (e) in the resultant polymer (1-13) was 70% by mass, 5% by mass, 20% by mass and 5% by mass, respectively.

### Evaluation Example 1

In Evaluation Example 1, prevention capability of soil redeposition was evaluated on the resultant polymers in Examples 1-1, 1-4, 1-6, 1-8 and 1-13, in accordance with the above-described method, to evaluate as a detergent composition. In this connection, in the following Table 1, result obtained by carrying out a similar experiment without using a polymer is also described for reference (in the column “No polymer addition” in the following Table 1).

TABLE 1

| | Prevention rate of soil redeposition (%) |
|---|---|
| Polymer (1-1) | 66.2 |
| Polymer (1-4) | 66.1 |
| Polymer (1-6) | 71.3 |
| Polymer (1-8) | 79.5 |
| Polymer (1-13) | 66.6 |
| No polymer addition | 58.0 |

As is clear from Table 1, polymers 1-1, 1-4, 1-6, 1-8 and 1-13 of the first embodiment have significantly excellent prevention capability of soil redeposition.

### Copolymer of the Second Embodiment

### Synthesis Example 1

### Synthesis of an Iminodiacetic Acid Derivative of Allyl Glycidyl Ether

Into a 2.5-L separable SUS flask equipped with a refluxing condenser and a stirrer, 500.0 g of deionized water, 399.3 g of iminodiacetic acid (IDA) and 500.0 g of 48 NaOH were charged, and the solution temperature was adjusted to 55° C. under stirring. Then, under stirring, into the reaction system maintained at 55° C., 342.4 g of allyl glycidyl ether (AGE) was gradually dropped over 2 hours. After completion of the dropping, the reaction solution was subjected to aging for 1 hour while maintaining at 55° C. to yield an aqueous solution of a 50% iminodiacetic acid derivative monomer of allyl glycidyl ether (hereinafter abbreviated as 50% AGE-IDA).

### Synthesis Example 2

### Synthesis of a Diethanol Amine Derivative of Allyl Glycidyl Ether

Into a 2.5-L separable SUS flask equipped with a refluxing condenser and a stirrer, 658.0 g of deionized water, 315.4 g of diethanol amine (DEA) were charged, and the solution temperature was adjusted to 55° C. under stirring. Then, under stirring, into the reaction system maintained at 55° C., 342.4 g of allyl glycidyl ether (AGE) was gradually dropped over 2 hours. After completion of the dropping, the reaction solution was subjected to aging while maintaining at 55° C. for 1 hour to yield an aqueous solution of a 50% diethanol amine derivative monomer of allyl glycidyl ether (hereinafter abbreviated as 50% AGE-DEA).

### Example 2-1

Into a 2.5-L separable SUS flask equipped with a refluxing condenser and a stirrer, 213.0 g of deionized water and 0.0106 g of Mohr's salt were charged and the solution was heated to 90° C. under stirring to prepare a polymerization reaction system. Then, under stirring, into the polymerization reaction system maintained at 90° C., 437.5 g of an aqueous solution of 80% AA, 250.0 g of 50% AGE-IDA as an aqueous solution of the monomer (D-2), 25.0 g of 100% St, 110.6 g of 15% NaPS, and 94.8 g of 35% SBS were each dropped from a separate nozzle. Dropping time of each solution was 180 minutes for 80% AA, 160 minutes for 50% AGE-IDA and 100% St; 185 minutes for 15% NaPS; and 175 minutes for 35% SBS. Dropping speed of each solutionwas kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 381.3 g of 48% NaOH was slowly dropped under stirring to neutralize the polymerization reaction solution. By the above procedure, an aqueous solution of the polymer (2-1) having a solid content of 45% and a weight average molecular weight of 25,000 was obtained. Composition of the repeating units (a), (c) and (d-2) in the resultant polymer (2-1) was 88% by mole, 4% by mole and 8% by mole, respectively.

### Example 2-2

Into a 2.5-L separable SUS flask equipped with a refluxing condenser and a stirrer, 235.0 g of deionized water and 0.0107 g of Mohr's salt were charged and the solution was heated to 90° C. under stirring to prepare a polymerization reaction system. Then, under stirring, into the polymerization reaction system maintained at 90° C., 437.5 g of 80% AA, 200.0 g of 50% AGE-IDA, 50.0 g of 100% St, 113.7 g of an 15% NaPS, and 97.5 g of 35% SBS were each dropped from a separate nozzle. Dropping time of each solution was 180 minutes for 80% AA, 160 minutes for 50% AGE-IDA and 100% St; 185 minutes for 15% NaPS; and 175 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 382.1 g of 48% NaOH was slowly dropped under stirring to neutralize the polymerization reaction solution. By the above procedure, an aqueous solution of the polymer (2-2) having a solid content of 45% and a weight average molecular weight of 34,000 was obtained. Composition of the repeating units (a), (c) and (d-2) in the resultant polymer (2-2) was 86% by mole, 8% by mole and 6% by mole, respectively.

### Example 2-3

Into a 2.5-L separable SUS flask equipped with a refluxing condenser and a stirrer, 258.0 g of deionized water and 0.0107 g of Mohr's salt were charged and the solution was heated to 90° C. under stirring to prepare a polymerization reaction system. Then, under stirring, into the polymerization reaction system maintained at 90° C., 437.5 g of 80% AA, 150.0 g of 50% AGE-IDA, 75.0 g of 100% St, 116.8 g of an 15% NaPS, and 100.1 g of 35% SBS were each dropped from a separate nozzle. Dropping time of each solution was 180 minutes for 80% AA, 160 minutes for 50% AGE-IDA and 100% St; 185 minutes for 15% NaPS; and 175 minutes for 35% SBS. Dropping speed of each solutionwas kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 382.5 g of 48% NaOH was slowly dropped under stirring to neutralize the polymerization reaction solution. By the above procedure, an aqueous solution of the polymer (2-3) having a solid content of 45% and a weight average molecular weight of 48,000 was obtained. Composition of the repeating units (a), (c) and (d-2) in the resultant polymer (2-3) was 83% by mole, 12% by mole and 5% by mole, respectively.

### Example 2-4

Into a 2.5-L separable SUS flask equipped with a refluxing condenser and a stirrer, 223.0 g of deionized water and 0.0105 g of Mohr's salt were charged and the solution was heated to 90° C. under stirring to prepare a polymerization reaction system. Then, under stirring, into the polymerization reaction system maintained at 90° C., 437.5 g of 80% AA, 250.0 g of 50% AGE-IDA, 25.0 g of 100% BA, 109.7 g of an 15% NaPS, and 94.0 g of 35% SBS were each dropped from a separate nozzle. Dropping time of each solution was 180 minutes for 80% AA; 160 minutes for 50% AGE-IDA and 100% BA; 185 minutes for 15% NaPS; and 175 minutes for 35% SBS. Dropping speed of each solutionwas kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 357.5 g of 48% NaOH was slowly dropped under stirring to neutralize the polymerization reaction solution. By the above procedure, an aqueous solution of the polymer (2-4) having a solid content of 45% and a weight average molecular weight of 23,000 was obtained. Composition of the repeating units (a), (b) and (d-2) in the resultant polymer (2-4) was 88% by mole, 4% by mole and 8% by mole, respectively.

### Example 2-5

Into a 2.5-L separable SUS flask equipped with a refluxing condenser and a stirrer, 210.0 g of deionized water and 0.0106 g of Mohr's salt were charged and the solution was heated to 90° C. under stirring to prepare a polymerization reaction system. Then, under stirring, into the polymerization reaction system maintained at 90° C., 437.5 g of 80% AA, 250.0 g of 50% AGE-DEA, 25.0 g of 100% St, 113.4 g of an 15% NaPS, and 97.2 g of 35% SBS were each dropped from a separate nozzle. Dropping time of each solution was 180 minutes for 80% AA; 160 minutes for 50% AGE-DEA and 100% St; 185 minutes for 15% NaPS; and 175 minutes for 35% SBS. Dropping speed of each solutionwas kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 381.3 g of 48% NaOH was slowly dropped under stirring to neutralize the polymerization reaction solution. By the above procedure, an aqueous solution of the polymer (2-5) having a solid content of 45% and a weight average molecular weight of 20,000 was obtained. Composition of the repeating units (a), (c) and (d-2) in the resultant polymer (2-5) was 86% by mole, 4% by mole and 10% by mole, respectively.

### Example 2-6

Into a 2.5-L separable SUS flask equipped with a refluxing condenser and a stirrer, 210.0 g of deionized water and 0.0106 g of Mohr's salt were charged and the solution was heated to 90° C. under stirring to prepare a polymerization reaction system. Then, under stirring, into the polymerization reaction system maintained at 90° C., 437.5 g of 80% AA, 200.0 g of 50% AGE-DEA, 25.0 g of 100% St, 50.0 g of 50% NIPAM, 108.9 g of 15% NaPS, and 93.3 g of 35% SBS were each dropped from a separate nozzle. Dropping time of each solution was 180 minutes for 80% AA; 160 minutes for 50% AGE-DEA, 100% St and 50% NIPAM; 185 minutes for 15% NaPS; and 175 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 382.1 g of 48% NaOH was slowly dropped under stirring to neutralize the polymerization reaction solution. By the above procedure, an aqueous solution of the polymer (2-6) having a solid content of 45% and a weight average molecular weight of 33,000 was obtained. Composition of the repeating units (a), (c), (d-2) and (e) in the resultant polymer (2-6) was 86% by mole, 4% by mole, 6% by mole and 4% by mole, respectively.

### Comparative Example 1

Into a 2.5-L separable SUS flask equipped with a refluxing condenser and a stirrer, 144.4 g of deionized water and 0.0150 g of Mohr's salt were charged and the solution was heated to 90° C. under stirring to prepare a polymerization reaction system. Then, under stirring, into the polymerization reaction system maintained at 90° C., 153.0 g of 80% AA, 174.6 g of 50% AGE-IDA, 53.3 g of an 15% NaPS, and 45.7 g of 35% SES were each dropped from a separate nozzle. Dropping time of each solution was 180 minutes for 80% AA, 90 minutes for 50% AGE-IDA; 190 minutes for 15% NaPS; and 170 minutes for 35% SBS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 141.7 g of 48% NaOH was slowly dropped under stirring to neutralize the polymerization reaction solution. By the above procedure, an aqueous solution of the comparative polymer (1) having a solid content of 45% and a weight average molecular weight of 17,000 was obtained. Composition of the repeating units (a) and (d-2) in the resultant comparative polymer was 85% by mole and 15% by mole, respectively.

### Evaluation Example 2

In Evaluation Example 2, prevention capability of soil redeposition was evaluated on the resultant polymers in Examples 2-1, 2-3 and 2-6, along with Comparative Example 1, in accordance with the above-described method, to evaluate as a detergent composition. In this connection, in the following Table 2, result obtained by carrying out a similar experiment without using a polymer is also described for reference (in the column “No polymer addition” in the following Table 2).

TABLE 2

| | Prevention rate of soil |
|---|---|
| | redeposition (%) |
| Polymer (2-1) | 60.9 |
| Polymer (2-3) | 60.9 |
| Polymer (2-6) | 62.1 |
| Comparative polymer(1) | 59.0 |
| No polymer addition | 58.0 |

As is clear from Table 1, polymers 2-1, 2-3 and 2-6 of the second embodiment have significantly excellent prevention capability of soil redeposition compared with that of the comparative polymer (1) composed of the repeating units (a) and (d-2) only.

### Copolymer of the Third Embodiment

### Example 3-1

Into a 2.5-L separable SUS flask equipped with a refluxing condenser, 224.4 g of deionized water and 0.022 g of Mohr's salt were charged and the solution was heated to 90° C. under stirring to prepare a polymerization reaction system. Then, under stirring, into the polymerization reaction system maintained at 90° C., 315.0 g of an aqueous solution of 80% AA, 90.0 g of 100% 2-hydroxyethyl methacrylate as the monomer (B) (hereinafter abbreviated as 100% HEMA), 18.0 g of 100% St, 14.6 g of 48% NaOH, 62.4 g of 35% SBS, and 58.2 g of an aqueous solution of 15% NaPS were each dropped from a separate nozzle. Dropping time of each solution was 180 minutes for 80% AA and 48% NaOH; 170 minutes for 100% HEMA and 100% St; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 262.5 g of 48% NaOH was slowly dropped under stirring to neutralize the polymerization reaction solution. By the above procedure, an aqueous solution of the polymer (3-1) having a solid content of 46% and a weight average molecular weight of 13,000 was obtained. Composition of the repeating units (a), (c) and (d-3) in the resultant polymer (3-1) was 80% by mole, 4% by mole and 16% by mole, respectively.

### Example 3-2

Into a 2.5-L separable SUS flask equipped with a refluxing condenser, 238.0 g of deionized water and 0.022 g of Mohr's salt were charged and the solution was heated to 90° C. under stirring to prepare a polymerization reaction system. Then, under stirring, into the polymerization reaction system maintained at 90° C., 315.0 g of 80% AA, 72.0 g of 100% HEMA, 36.0 g of 100% St, 14.6 g of 48% NaOH, 62.8 g of 35% SBS, and 58.7 g of 15% NaPS were each dropped from a separate nozzle. Dropping time of each solution was 180 minutes for 80% AA and 48% NaOH; 170 minutes for 100% HEMA and 100% St; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 262.5 g of 48% NaOH was slowly dropped under stirring to neutralize the polymerization reaction solution. By the above procedure, an aqueous solution of the polymer (3-2) having a solid content of 45% and a weight average molecular weight of 16,000 was obtained. Composition of the repeating units (a), (c) and (d-2) in the resultant polymer (3-2) was 80% by mole, 8% by mole and 12% by mole, respectively.

### Example 3-3

Into a 2.5-L separable SUS flask equipped with a refluxing condenser, 255.0 g of deionized water and 0.020 g of Mohr's salt were charged and the solution was heated to 90° C. under stirring to prepare a polymerization reaction system. Then, under stirring, into the polymerization reaction system maintained at 90° C., 216.0 g of 80% AA, 155.5 g of 100% HEMA, 17.3 g of 100% St, 10.0 g of 48% NaOH, 64.5 g of 35% SBS, and 75.2 g of 15% NaPS were each dropped from a separate nozzle. Dropping time of each solution was 180 minutes for 80% AA and 48% NaOH; 170 minutes for 100% HEMA and 100% St; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 170.0 g of 48% NaOH was slowly dropped under stirring to neutralize the polymerization reaction solution. By the above procedure, an aqueous solution of the polymer (3-3) having a solid content of 45% and a weight average molecular weight of 11,000 was obtained. Composition of the repeating units (a), (c) and (d-3) in the resultant polymer (3-3) was 64% by mole, 4% by mole and 32% by mole, respectively.

### Example 3-4

Into a 2.5-L separable SUS flask equipped with a refluxing condenser, 263.0 g of deionized water and 0.021 g of Mohr's salt were charged and the solution was heated to 90° C. under stirring to prepare a polymerization reaction system. Then, under stirring, into the polymerization reaction system maintained at 90° C., 225.0 g of 80% AA, 162.0 g of 100% HEMA, 18.0 g of 100% BA, 10.4 g of 48% NaOH, 66.6 g of 35% SBS, and 77.7 g of 15% NaPS were each dropped from a separate nozzle. Dropping time of each solution was 180 minutes for 80% AA and 48% NaOH; 170 minutes for 100% HEMA and 100% BA; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 177.1 g of 48% NaOH was slowly dropped under stirring to neutralize the polymerization reaction solution. By the above procedure, an aqueous solution of the polymer (3-4) having a solid content of 45% and a weight average molecular weight of 11,000 was obtained. Composition of the repeating units (a), (b) and (d-3) in the resultant polymer (3-4) was 64% by mole, 4% by mole and 32% by mole, respectively.

### Example 3-5

Into a 2.5-L separable SUS flask equipped with a refluxing condenser, 246.0 g of deionized water and 0.020 g of Mohr's salt were charged and the solution was heated to 90° C. under stirring to prepare a polymerization reaction system. Then, under stirring, into the polymerization reaction system maintained at 90° C., 216.0 g of 80% AA, 162.4 g of 100% HEMA, 10.4 g of 100% BA, 10.0 g of 48% NaOH, 63.9 g of 35% SBS, and 74.6 g of 15% NaPS were each dropped from a separate nozzle. Dropping time of each solution was 180 minutes for 80% AA and 48% NaOH; 170 minutes for 100% HEMA and 100% BA; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 170.0 g of 48% NaOH was slowly dropped under stirring to neutralize the polymerization reaction solution. By the above procedure, an aqueous solution of the polymer (3-5) having a solid content of 46% and a weight average molecular weight of 10,000 was obtained. Composition of the repeating units (a), (b) and (d-3) in the resultant polymer (3-5) was 64% by mole, 2% by mole and 34% by mole, respectively.

### Example 3-6

Into a 2.5-L separable SUS flask, equipped with a refluxing condenser, 245.0 g of deionized water and 0.022 g of Mohr's salt were charged and the solution was heated to 90° C. under stirring to prepare a polymerization reaction system. Then, under stirring, into the polymerization reaction system maintained at 90° C., 315.0 g of 80% AA, 72.0 g of 100% HEMA, 18.0 g of 100% BA, 18.0 g of 100% St, 14.6 g of 48% NaOH, 61.8 g of 35% SBS, and 57.7 g of 15% NaPS were each dropped from a separate nozzle. Dropping time of each solution was 180 minutes for 80% AA and 48% NaOH; 170 minutes for 100% HEMA, 100% BA and 100% St; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 247.9 g of 48% NaOH was slowly dropped under stirring to neutralize the polymerization reaction solution. By the above procedure, an aqueous solution of the polymer (3-6) having a solid content of 45% and a weight average molecular weight of 15,000 was obtained. Composition of the repeating units (a), (b), (c) and (d-3) in the resultant polymer (3-6) was 81% by mole, 3% by mole, 3% by mole and 13% by mole, respectively.

### Example 3-7

Into a 2.5-L separable SUS flask equipped with a refluxing condenser, 195.0 g of deionized water and 0.021 g of Mohr's salt were charged and the solution was heated to 90° C. under stirring to prepare a polymerization reaction system. Then, under stirring, into the polymerization reaction system maintained at 90° C., 315.0 g of 80% AA, 72.0 g of 100% HEMA, 18.0 g of 100% EHA as the monomer (C), 18.0 g of 100% St, 14.6 g of 48% NaOH, 61.2 g of 35% SBS, and 57.1 g of 15% NaPS were each dropped from a separate nozzle. Dropping time of each solution was 180 minutes for 80% AA and 48% NaOH; 160 minutes for 100% HEMA and 100% St; 170 minutes for 100% EHA; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 247.9 g of 48% NaOH was slowly dropped under stirring to neutralize the polymerization reaction solution. By the above procedure, an aqueous solution of the polymer (3-7) having a solid content of 45% and a weight average molecular weight of 12,000 was obtained. Composition of the repeating units (a), (b), (c) and (d-3) in the resultant polymer (3-7) was 82% by mole, 2% by mole, 3% by mole and 13% by mole, respectively.

### Example 3-8

Into a 2.5-L separable SUS flask equipped with a refluxing condenser, 240.0 g of deionized water and 0.023 g of Mohr's salt were charged and the solution was heated to 90° C. under stirring to prepare a polymerization reaction system. Then, under stirring, into the polymerization reaction system maintained at 90° C., 315.0 g of 80% AA, 72.0 g of 100% HEMA, 18.0 g of 100% St, 36.0 g of 50% NIPAM, 14.6 g of 48% NaOH, 60.4 g of 35% SBS, and 56.4 g of 15% NaPS were each dropped from a separate nozzle. Dropping time of each solution was 180 minutes for 80% AA and 48% NaOH; 170 minutes for 100% HEMA, 100% St and 50% NIPAM; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 262.5 g of 48% NaOH was slowly dropped under stirring to neutralize the polymerization reaction solution. By the above procedure, an aqueous solution of the polymer (3-8) having a solid content of 45% and a weight average molecular weight of 19,000 was obtained. Composition of the repeating units (a), (c), (d-3) and (e) in the resultant polymer (3-8) was 80% by mole, 4% by mole, 13% by mole and 4% by mole, respectively.

### Evaluation Example 3

In Evaluation Example 3, prevention capability of soil redeposition was evaluated on the resultant polymers in Examples 3-2, 3-3, 3-4, 3-6, and 3-8, in accordance with the above-described method, to evaluate as a detergent composition. In this connection, in the following Table 3, result obtained by carrying out a similar experiment without using a polymer is also described for reference (in the column “No polymer addition” in the following Table 3).

TABLE 3

| | Prevention rate of soil redeposition (%) |
|---|---|
| Polymer (3-2) | 63.9 |
| Polymer (3-3) | 62.9 |
| Polymer (3-4) | 62.6 |
| Polymer (3-6) | 65.2 |
| Polymer (3-8) | 66.3 |
| No polymer addition | 58.0 |

As is clear from Table 1, polymers 3-2, 3-3, 3-4, 3-6 and 3-8 of the third embodiment have significantly excellent prevention capability of soil redeposition.

### Copolymer of the Fourth Embodiment

### Example 4-1

Into a 2.5-L separable SUS flask equipped with a refluxing condenser, 84.0 g of deionized water and 0.022 g of Mohr's salt were charged and the solution was heated to 90° C. under stirring to prepare a polymerization reaction system. Then, under stirring, into the polymerization reaction system maintained at about 90° C., 315.0 g of an aqueous solution of 80% AA, 225 g of an aqueous solution of 40% sodium 3-allyloxy-2-hydroxypropane sulfonate as the monomer (B) (hereinafter abbreviated as 40% HAPS), 18.0 g of 100% St, 70.1 g of an aqueous solution of 35% SBS, and 81.8 g of 15% NaPS were each dropped from a separate nozzle. Dropping time of each solution was 180 minutes for 80% AA; 150 minutes for 40% HAPS and 100% St; 175 minutes for 35% SES; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 247.9 g of 48% NaOH was slowly dropped under stirring to neutralize the polymerization reaction solution. By the above procedure, an aqueous solution of the polymer (4-1) having a solid content of 46% and a weight average molecular weight of 12,000 was obtained. Composition of the repeating units (a), (c) and (d-4) in the resultant polymer (4-1) was 86% by mole, 4% by mole and 10% by mole, respectively.

### Example 4-2

Into a 2.5-L separable SUS flask equipped with a refluxing condenser, 84.0 g of deionized water and 0.022 g of Mohr's salt were charged and the solution was heated to 90° C. under stirring to prepare a polymerization reaction system. Then, under stirring, into the polymerization reaction system maintained at about 90° C., 315.0 g of 80% AA, 225.0 g of 40% HAPS, 18.0 g of 100% St, 70.1 g of 35% SBS, and 81.8 g of 15% NaPS were each dropped from a separate nozzle. Dropping time of each solution was 180 minutes for 80% AA; 150 minutes for 40% HAPS; 130 minutes for 100% St; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 247.9 g of 48% NaOH was slowly dropped under stirring to neutralize the polymerization reaction solution. By the above procedure, an aqueous solution of the polymer (4-2) having a solid content of 46% and a weight average molecular weight of 10,000 was obtained. Composition of the repeating units (a), (c) and (d-4) in the resultant polymer (4-2) was 86% by mole, 4% by mole and 10% by mole, respectively.

### Example 4-3

Into a 2.5-L separable SUS flask equipped with a refluxing condenser, 125.0 g of deionized water and 0.022 g of Mohr's salt were charged and the solution was heated to 90° C. under stirring to prepare a polymerization reaction system. Then, under stirring, into the polymerization reaction system maintained at about 90° C., 315.0 g of 80% AA, 180.0 g of 40% HAPS, 36.0 g of 100% St, 71.6 g of 35% SBS, and 83.6 g of 15% NaPS were each dropped from a separate nozzle. Dropping time of each solution was 180 minutes for 80% AA; 150 minutes for 40% HAPS and 100% St; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 247.9 g of 48% NaOH was slowly dropped under stirring to neutralize the polymerization reaction solution. By the above procedure, an aqueous solution of the polymer (4-3) having a solid content of 46% and a weight average molecular weight of 14,000 was obtained. Composition of the repeating units (a), (c) and (d-4) in the resultant polymer (4-3) was 84% by mole, 8% by mole and 8% by mole, respectively.

### Example 4-4

Into a 2.5-L separable SUS flask equipped with a refluxing condenser, 125.0 g of deionized water and 0.022 g of Mohr's salt were charged and the solution was heated to 90° C. under stirring to prepare a polymerization reaction system. Then, under stirring, into the polymerization reaction system maintained at about 90° C., 315.0 g of 80% AA, 180.0 g of 40% HAPS, 36.0 g of 100% St, 71.6 g of 35% SBS, and 83.6 g of 15% NaPS were each dropped from a separate nozzle. Dropping time of each solution was 180 minutes for 80% AA; 150 minutes for 40% HAPS; 130 minutes for 100% St; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 247.9 g of 48% NaOH was slowly dropped under stirring to neutralize the polymerization reaction solution. By the above procedure, an aqueous solution of the polymer (4-4) having a solid content of 46% and a weight average molecular weight of 16,000 was obtained. Composition of the repeating units (a), (c) and (d-4) in the resultant polymer (4-4) was 84% by mole, 8% by mole and 8% by mole, respectively.

### Example 4-5

Into a 2.5-L separable SUS flask equipped with a refluxing condenser, 84.0 g of deionized water and 0.022 g of Mohr's salt were charged and the solution was heated to 90° C. under stirring to prepare a polymerization reaction system. Then, under stirring, into the polymerization reaction system maintained at about 90° C., 315.0 g of 80% AA, 225.0 g of 40% HAPS, 18.0 g of 100% BA as the monomer (C), 69.5 g of 35% SBS and 81.1 g of 15% NaPS were each dropped from a separate nozzle. Dropping time of each solution was 180 minutes for 80% AA; 150 minutes for 40% HAPS; 120 minutes for 100% BA; 175 minutes for 35% SBS; and 190 minutes for 15%, NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 247.9 g of 48% NaOH was slowly dropped under stirring to neutralize the polymerization reaction solution. By the above procedure, an aqueous solution of the polymer (4-5) having a solid content of 46% and a weight average molecular weight of 9,100 was obtained. Composition of the repeating units (a), (b) and (d-4) in the resultant polymer (4-5) was 86% by mole, 3% by mole and 10% by mole, respectively.

### Example 4-6

Into a 2.5-L separable SUS flask equipped with a refluxing condenser, 125.0 g of deionized water and 0.022 g of Mohr's salt were charged and the solution was heated to 90° C. under stirring to prepare a polymerization reaction system. Then, under stirring, into the polymerization reaction system maintained at about 90° C., 315.0 g of 80% AA, 180.0 g of 40% HAPS, 18.0 g of 100% BA, 18.0 g of 100% St, 71.0 g of 35% SBS, and 82.9 g of 15% NaPS were each dropped from a separate nozzle. Dropping time of each solution was 180 minutes for 80% AA; 150 minutes for 40% HAPS; 120 minutes for 100% BA and 100% St; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 247.9 g of 48% NaOH was slowly dropped under stirring to neutralize the polymerization reaction solution. By the above procedure, an aqueous solution of the polymer (4-6) having a solid content of 46% and a weight average molecular weight of 7,000 was obtained. Composition of the repeating units (a), (b), (c) and (d-4) in the resultant polymer (4-6) was 84% by mole, 4% by mole, 4% by mole and 8% by mole, respectively.

### Example 4-7

Into a 2.5-L separable SUS flask equipped with a refluxing condenser, 125.0 g of deionized water and 0.022 g of Mohr's salt were charged and the solution was heated to 90° C. under stirring to prepare a polymerization reaction system. Then, under stirring, into the polymerization reaction system maintained at about 90° C., 315.0 g of 80% AA, 180.0 g of 40% HAPS, 18.0 g of 100% EHA, 18.0 g of 100% St, 70.3 g of 35% SBS, and 82.1 g of 15% NaPS were each dropped from a separate nozzle. Dropping time of each solution was 180 minutes for 80% AA; 150 minutes for 40% HAPS; 120 minutes for 100% EHA and 100% St; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 247.9 g of 48% NaOH was slowly dropped under stirring to neutralize the polymerization reaction solution. By the above procedure, an aqueous solution of the polymer (4-7) having a solid content of 46% and a weight average molecular weight of 6,500 was obtained. Composition of the repeating units (a), (b), (c) and (d-4) in the resultant polymer (4-7) was 85% by mole, 3% by mole, 4% by mole and 8% by mole, respectively.

### Example 4-8

Into a 2.5-L separable SUS flask equipped with a refluxing condenser, 140.0 g of deionized water and 0.023 g of Mohr's salt were charged and the solution was heated to 90° C. under stirring to prepare a polymerization reaction system. Then, under stirring, into the polymerization reaction system maintained at about 90° C., 315.0 g of 80% AA, 180.0 g of 40% HAPS, 18.0 g of 100% St, 36.0 g of 50% NIPAM, 68.7 g of 35% SBS, and 80.1 g of 15% NaPS were each dropped from a separate nozzle. Dropping time of each solution was 180 minutes for 80% AA; 150 minutes for 40% HAPS; 120 minutes for 100% St; 170 minutes for 50% NIPAM; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 247.9 g of 48% NaOH was slowly dropped under stirring to neutralize the polymerization reaction solution. By the above procedure, an aqueous solution of the polymer (4-8) having a solid content of 46% and a weight average molecular weight of 18,000 was obtained. Composition of the repeating units (a), (c), (d-4) and (e) in the resultant polymer (4-8) was 84% by mole, 4% by mole, 8% by mole and 4% by mole, respectively.

### Comparative Example 2-1

Into a 2.5-L separable SUS flask equipped with a refluxing condenser, 125.0 g of deionized water and 45.0 g of 40% HAPS were charged and the solution was heated to 90° C. under stirring to prepare a polymerization reaction system. Then, under stirring, into the polymerization reaction system maintained at about 90° C., 226.8 g of 80% AA, 297.0 g of 40% HAPS, 70.1 g of 35% SBS, and 82.8 g of 15% NaPS were each dropped from a separate nozzle. Dropping time of each solution was 180 minutes for 80% AA; 130 minutes for 40% HAPS; 180 minutes for 35% SBS; and 200 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 210.0 g of 48% NaOH was slowly dropped under stirring to neutralize the polymerization reaction solution. By the above procedure, an aqueous solution of the comparative polymer (2-1) having a solid content of 46% and a weight average molecular weight of 13,000 was obtained. Composition of the repeating units (a) and (d-4) in the resultant comparative polymer (2-1) was 82% by mole and 18% by mole, respectively.

### Comparative Example 2-2

Into a 2.5-L separable SUS flask equipped with a refluxing condenser, 84.0 g of deionized water and 0.022 g of Mohr's salt were charged and the solution was heated to 90° C. under stirring to prepare a polymerization reaction system. Then, under stirring, into the polymerization reaction system maintained at about 90° C., 315.0 g of 80% AA, 225.0 g of 40% HAPS, 18.0 g 100% methyl methacrylate (hereinafter abbreviated as 100% MMA), 70.2 g of 35% SBS and 81.9 g of 15% NaPS were each dropped from a separate nozzle. Dropping time of each solution was 180 minutes for 80% AA, 100% MMA and 48% NaOH; 150 minutes for 40% HAPS; 175 minutes for 35% SBS; and 190 minutes for 15% NaPS. Dropping speed of each solution was kept constant, and dropping of each solution was continuous.

After completion of dropping of 80% AA, the above-described reaction solution was maintained at 90° C. (aging) for further 30 minutes to complete polymerization. After completion of polymerization, the polymerization reaction solution was gradually cooled, and 247.9 g of 48% NaOH was slowly dropped under stirring to neutralize the polymerization reaction solution. By the above procedure, an aqueous solution of the comparative polymer (4-2) having a solid content of 46% and a weight average molecular weight of 7,000 was obtained. Composition of the repeating units (a) and (d-4), along with the repeating unit derived from MMA in the resultant comparative polymer (4-2) was 86% by mole, 10% by mole and 4% by mole, respectively.

### Evaluation Example 4

In Evaluation Example 4, prevention capability of soil redeposition was evaluated on the resultant polymers in Examples 4-1, 4-3, 4-4, 4-5, 4-6, 4-7 and 4-8, along with Comparative Examples 4-1 and 4-2, in accordance with the above-described method, to evaluate as a detergent composition. In this connection, in the following Table 4, result obtained by carrying out a similar experiment without using a polymer is also described for reference (in the column “No polymer addition” in the following Table 4).

TABLE 4

| | Prevention rate of soil redeposition (%) |
|---|---|
| Polymer (4-1) | 63.7 |
| Polymer (4-3) | 63.3 |
| Polymer (4-4) | 76.1 |
| Polymer (4-5) | 63.2 |
| Polymer (4-6) | 65.7 |
| Polymer (4-7) | 68.5 |
| Polymer (4-8) | 64.3 |
| Comparative polymer (2-1) | 59.5 |
| Comparative polymer (2-2) | 59.0 |
| No polymer addition | 58.0 |

As is clear from Table 1, polymers 4-1, 4-3, 4-4, 4-5, 4-6, 4-7 and 4-8 of the fourth embodiment have significantly excellent prevention capability of soil redeposition compared with those of the comparative polymer 2-1 and the comparative polymer 2-2.

The present application is based on Japanese patent application No. 2006-23858, Japanese Patent Application No. 2006-23860, Japanese Patent Application No. 2006-23862, and Japanese Patent Application No. 2006-23863, each filed on Jan. 31, 2006, whose disclosure contents are incorporated herein by reference as its entirety.

1. A (meth)acrylic acid-based copolymer having, as repeating units:
a repeating unit (a) derived from a (meth)acrylic acid-based monomer (A) represented by the following formula (1): 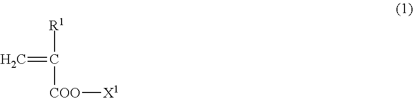
wherein R¹ represents a hydrogen atom or a methyl group, and X¹ represents a hydrogen atom, a metal atom, an ammonium group or an organic amine group; and
a repeating unit (b) derived from an alkyl(meth)acrylate-based monomer (B) represented by the following formula (2): 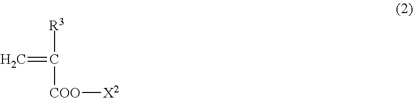
wherein R³ represents a hydrogen atom or a methyl group, and X² represents a (C1 to C12) alkyl group or a (C3 to C12) cycloalkyl group or a (C5 to C12) hydroxyalkyl group; or
a repeating unit (c) derived from a vinyl aromatic-based monomer (C); and
1 or, 2 or more kinds of repeating units (d) selected from the group consisting of:
a repeating unit (d-1) derived from an unsaturated monomer (D-1) represented by the following formula (3):
R⁴—O-(AO)ₙ—R⁵ (3)
wherein R⁴ represents a (C2 to C5) alkenyl group; AO may be the same or different and represents a group derived from a (C2 to C20) alkylene oxide; R5 represents a hydrogen atom or a (C2 to C5) alkyl group; and n is an integer of 1 to 200;
a repeating unit (d-2) derived from an unsaturated monomer (D-2) represented by the following formula (4): 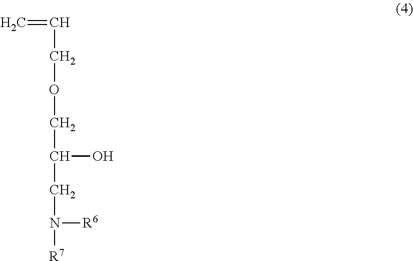
wherein R⁶ and R⁷ may be the same or different and represent a hydrogen atom or an organic group;
a repeating unit (d-3) derived from a hydroxyalkyl(meth)acrylate-based monomer (D-3) represented by the following formula (5): 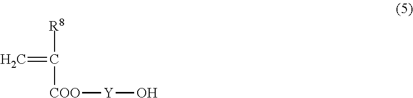
wherein R⁸ represents a hydrogen atom or a methyl group, and Y represents a (C1 to C4) alkylene group; and
a repeating unit (d-4) derived from a sulfonic acid group containing monomer (D-4) represented by the following formula (6): 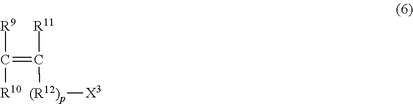
wherein R⁹, R¹⁰ and R¹¹ may be the same or different and represent a hydrogen atom or a methyl group, p represents 0 or 1, provided that when p is 1, R¹² represents —CH₂—, —CH₂—CH₂—, —CH₂—O—CH₂—, —CO—O—CH₂—CH₂—, or —CO—NH—C(CH₃)₂—, and X³ represents —SO₃X⁴ or —CHR¹³—CH₂R¹⁴, and in this case, X⁴ has the same definition as in X¹ in the above formula (1), and R¹³ and R¹⁴ may be the same or different and represent —OH or —SO₃X⁴, and at least one of R¹³ and R¹⁴ represents —SO₃X⁴.

2. The (meth)acrylic acid-based copolymer according to claim 1, comprising said repeating unit (d-1), where content of said repeating unit (d-1) is equal to or more than 5% by mass and less than 70% by mass, content of said repeating unit (a) is equal to or more than 30% by mass and less than 95% by mass, and total content of said repeating units (b) and (c) is over 0% by mass and equal to or less than 50% by mass, based on total content of said repeating units (a) to (d) as 100% by mass.

3. The (meth)acrylic acid-based copolymer according to claim 1, comprising said repeating unit (d-1), where R⁴ in said formula (3) represents CH₂═C(CH₃)CH₂CH₂— or CH₂═CHCH₂—, and R⁵ represents a hydrogen atom.

4. The (meth)acrylic acid-based copolymer according to claim 1, comprising said repeating unit (d-1), and further comprising a repeating unit (e) derived from other monomer in an amount of over 0% by mass and equal to or less than 10% by mass, based on total content of said repeating units (a) to (d) as 100% by mass.

5. The (meth)acrylic acid-based copolymer according to claim 1, comprising said repeating unit (d-2), where content of said repeating unit (d-2) is equal to or more than 5% by mole and less than 30% by mole, content of said repeating unit (a) is equal to or more than 70% by mole and less than 95% by mole, and total content of said repeating units (b) and (c) is over 0% by mole and equal to or less than 50% by mole, based on total content of said repeating units (a) to (d), as 100% by mole.

6. The (meth)acrylic acid-based copolymer according to claim 1, comprising said repeating unit (d-2), where R⁶ and R⁷ in said formula (4) may be the same or different, and represents an any a group selected from the group consisting of the following (I) to (V):
(I) a hydrogen atom,
(II) an organic group containing a carboxylic acid group or a salt form thereof,
(III) an organic group containing a sulfonic acid group or a salt form thereof,
(IV) an organic group containing a hydroxyl group, and
(V) an organic group containing an amino group.

7. The (meth)acrylic acid-based copolymer according to claim 1, comprising said repeating unit (d-2), where R⁶ and R⁷ in said formula (4) may be the same or different and represent a group selected from the group consisting of the following formulae (i) to (ix): 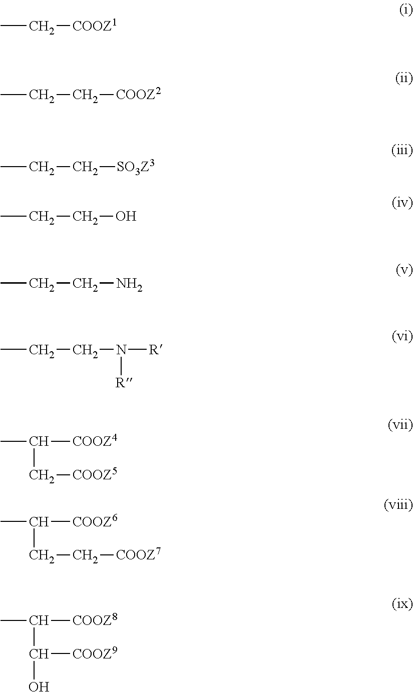
wherein Z¹ to Z⁹ each independently represent a hydrogen atom, an alkali metal, an alkaline earth metal, an ammonium group or an organic amine group. R′ and R″ are each independently the same as R⁶ or R⁷ and represent a group selected from the group consisting of a (C1 to c12) alkyl group or aryl group, or a (C3 to c12) cycloalkyl group.

8. The (meth)acrylic acid-based copolymer according to claim 1, comprising said repeating unit (d-3), where content of said repeating unit (d-3) is equal to or more than 5% by mole and less than 70% by mole, content of said repeating unit (a) is equal to or more than 30% by mole and less than 95% by mole, and total content of said repeating units (b) and (c) is over 0% by mole and equal to or less than 50% by mole, based on total content of said repeating units (a) to (d), as 100% by mole.

9. The (meth)acrylic acid-based copolymer according to claim 1, comprising said repeating unit (d-3), where Y in said formula (5) represents an ethylene group.

10. The (meth)acrylic acid-based copolymer according to claim 1, comprising said repeating unit (d-4), where content of said repeating unit (d-4) is equal to or more than 5% by mole and less than 30% by mole, content of said repeating unit (a) is equal to or more than 70% by mole and less than 95% by mole, and total content of said repeating units (b) and (c) is over 0% by mole and equal to or less than 50% by mole, based on total content of said repeating units (a) to (d), as 100% by mole.

11. The (meth)acrylic acid-based copolymer according to claim 1, comprising said repeating unit (d-4), where p is 1, and R¹² represents —CH₂—O—CH₂— or —CH₂—, in said formula (6).

12. The (meth)acrylic acid-based copolymer according to claim 1, comprising said repeating unit (d-4), where X³ in said formula (6) represents —CH(OH)—CH₂SO₃X⁴.

13. The (meth)acrylic acid-based copolymer according to claim 1, comprising said repeating unit (d-2), (d-3) or (d-4), and further comprising the repeating unit (e) derived from the other monomer, in an amount of over 0% by mole and equal to or less than 10% by mole, based on total content of said repeating units (a) to (d), as 100% by mole.

14. The (meth)acrylic acid-based copolymer according to claim 1, comprising said repeating unit (c), where said repeating unit (c) has an aromatic hydrocarbon group.

15. The (meth)acrylic acid-based copolymer for a detergent, according to claim 1.

16. The (meth)acrylic acid-based copolymer according to claim 15, wherein prevention rate of soil redeposition is equal to or larger than 60.9%.

17. A detergent composition comprising the (meth)acrylic acid-based copolymer according to claim 1.

18. A method for producing a (meth)acrylic acid-based copolymer comprising the step for polymerizing monomer components comprising;
a (meth)acrylic acid-based monomer (A) represented by the following formula (1): 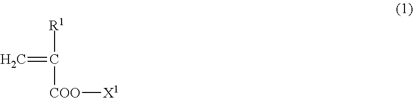
wherein R¹ represents a hydrogen atom or a methyl group, and X¹ represents a hydrogen atom, a metal atom, an ammonium group or an organic amine group; and
an alkyl(meth)acrylate-based monomer (B) represented by the following formula (2): 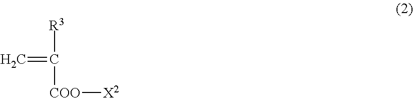
wherein R³ represents a hydrogen atom or a methyl group, and X² represents a (C1 to C12) alkyl group or a (C3 to C12) cycloalkyl group or a (C5 to C12) hydroxyalkyl group; or
a vinyl aromatic-based monomer (C); and
1 or, 2 or more kinds of monomers (D) selected from the group consisting of:
an unsaturated monomer (D-1) represented by the following formula (3):
R⁴—O-(AO)ₙ—R⁵ (3)
wherein R⁴ represents a (C2 to C5) alkenyl group; AO may be the same or different and represents a group derived from a (C2 to C20) alkylene oxide; R5 represents a hydrogen atom or a (C2 to C5) alkyl group; and n is an integer of 1 to 200;
an unsaturated monomer (D-2) represented by the following formula (4): 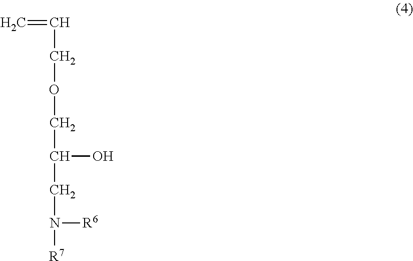
wherein R⁶ and R⁷ may be the same or different and represent a hydrogen atom or an organic group;
a hydroxyalkyl(meth)acrylate-based monomer (D-3) represented by the following formula (5): 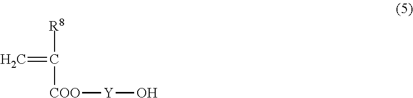
wherein R⁸ represents a hydrogen atom or a methyl group, and Y represents a (C1 to C4) alkylene group; and
a sulfonic acid group containing monomer (D-4) represented by the following formula (6): 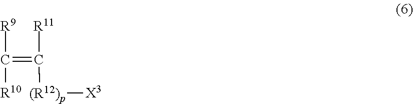
wherein R⁹, R¹⁰ and R¹¹ may be the same or different and represent a hydrogen atom or a methyl group, p represents 0 or 1, provided that when p is 1, R¹² represents —CH₂—, —CH₂—CH₂—, —CH₂—O—CH₂—, —CO—O—CH₂—CH₂—, or —CO—NH—C(CH₃)₂—, and X³ represents —SO₃X⁴ or —CHR¹³—CH₂R¹⁴, and in this case, X⁴ has the same definition as in X¹ in the above formula (1), and R¹³ and R¹⁴ may be the same or different and represent —OH or —SO₃X⁴, and at least one of R¹³ and R¹⁴ represents —SO₃X⁴,
in a solvent comprising water in an amount of equal to or more than 50% by mass, and in the presence of a chain transfer agent.

19. The method of production according to claim 18, where said monomer components comprises said monomer (D-1), and content of said monomer (D-1) is equal to or more than 5% by mass and less than 90% by mass, content of said monomer (A) is equal to or more than 10% by mass and less than 95% by mass, and total content of said monomers (B) and (C) is over 0% by mass and equal to or less than 50% by mass, based on total content of said monomers (A) to (D) in said monomer components, as 100% by mass.

20. The method of production according to claim 18, where said monomer components comprises said monomer (D-2), and content of said monomer (D-2) is equal to or more than 5% by mole and less than 50% by mass, content of said monomer (A) is equal to or more than 50% by mole and less than 95% by mole, and total content of said monomers (B) and (C) is over 0% by mole and equal to or less than 50% by mole, based on total content of said monomers (A) to (D) in said monomer components, as 100% by mole.

21. The method of production according to claim 18, where said monomer components comprises said monomer (D-3), and content of said monomer (D-3) is equal to or more than 5% by mole and less than 70% by mole, content of said monomer (A) is equal to or more than 30% by mole and less than 95% by mole, and total content of said monomers (B) and (C) is over 0% by mole and equal to or less than 50% by mole, based on total content of said monomers (A) to (D) in said monomer components, as 100% by mole.

22. The method of production according to claim 18, where said monomer components comprises said monomer (D-4), and content of said monomer (D-4) is equal to or more than 5% by mole and less than 50% by mole, content of said monomer (A) is equal to or more than 50% by mole and less than 95% by mole, and total content of said monomers (B) and (C) is over 0% by mole and equal to or less than 50% by mole, based on total content of said monomers (A) to (D) in said monomer components, as 100% by mole.

23. The method for producing according to claim 18, wherein said chain transfer agent comprises at least one of sulfurous acid and a sulfite salt.
